(19) United States
(12) Patent Application Publication
(10) Pub. No.: US 2024/0140082 A1
(43) Pub. Date: May 2, 2024

(54) LASER-BONDED OPTICAL ASSEMBLIES

(71) Applicant: CORNING INCORPORATED, Corning, NY (US)

(72) Inventors: Justin Paul Gales, Palmyra, NY (US); Robert Dennis Grejda, Fairport, NY (US); Colleen Renee Hagen, Farmington, NY (US); Patrick Shea Hendershot, Fairport, NY (US); Todd Robert McMichael, Rochester, NY (US)

(21) Appl. No.: 18/376,892

(22) Filed: Oct. 5, 2023

Related U.S. Application Data
(60) Provisional application No. 63/421,679, filed on Nov. 2, 2022.

(51) Int. Cl. B32B 37/04; B32B 3/26; B32B 17/06; C03B 23/22

(52) U.S. Cl. CPC B32B 37/04; B32B 3/266; B32B 17/06; C03B 23/22; G02B 5/04

(57) ABSTRACT

Methods, apparatuses, devices, and optical components are described. One or more materials used in an optical system may be bonded together using a pulsed laser beam. The bonding process may include transmitting a pulsed laser to irradiate an interface between two components, which may include two optical components or an optical component and a mounting component. The pulsed laser may generate one or more bonding locations where the components are in relatively close contact with each other, which may secure the components together via at least partial melting of material at one or more surfaces of the components. In some examples, the pulsed laser may be scanned over the bonding locations some quantity of times and/or using a pattern to achieve the bond. In some aspects, one or more absorbing layers may be added to the components.

This application claims the benefit of priority of U.S. Provisional Application Ser. No. 63/421,679 filed on Nov. 2, 2022, the content of which is relied upon and incorporated herein by reference in its entirety.

### FIELD OF TECHNOLOGY

The present disclosure relates generally to optical assemblies, and more specifically to laser-bonded optical assemblies.

### BACKGROUND

Optical systems may have various applications in research, medical procedures, fabrication and microfabrication processes, manufacturing, and the like. For example, optical systems may include imaging and illumination systems for applications such as photolithography, semiconductor inspection, microscope assemblies, polarization components, among other examples. In such systems, one or more optical components (e.g., refractive optics, reflective optics, diffractive optics) may be secured to various structural components (e.g., housings, holders), secured to other optical components, or both. Such assemblies may be combined with other components (e.g., a camera, a substrate stage, a light source) of an optical system to function with some optical performance specification for transmission, transmission uniformity, wavefront performance, polarization performance, and/or alignment fidelity, for example, to perform inspection, measurement, or lithographic functions. In some examples, adhesive materials may be used to mount optical components to support structures or to each other. Such adhesive materials, however, may have limited use (or may not be used) in some systems (e.g., systems operating at relatively high power level, systems operating with some wavelengths of light), and the application of adhesive materials for bonding optical components may result in degradation, contamination, and reliability issues.

### SUMMARY

The methods, apparatus, and devices of this disclosure each have several new and innovative aspects. This summary provides some examples of these new and innovative aspects, but the disclosure may include new and innovative aspects not included in this summary.

The described techniques relate to methods, apparatus, and systems for laser-bonded optical assemblies. For example, one or more materials used in an optical system may be bonded together using a pulsed laser beam. Generally, the bonding process may include transmitting a pulsed laser having some wavelength (e.g., ultraviolet (UV) wavelengths, infrared (IR) wavelengths, visible light wavelengths) to irradiate an interface between two components, which may include two optical components (e.g., lenses, mirrors, prisms, or the like) or an optical component and a mounting component (e.g., a housing or other type of support structure). The pulsed laser may generate one or more bonding locations where the components are in relatively close contact with each other (e.g., within some threshold distance between opposing surfaces), which may secure the components together via partial melting of material at one or more surfaces. In addition, the pulsed laser may be scanned over the bonding locations some quantity of times (e.g., a threshold quantity of times, for some duration of time) and using a pattern to bond the components together. In some aspects, one or more absorbing layers may be added to the components to enhance adhesion and broaden the process window for joining materials together. The described techniques may accordingly enable permanent and stable bonds between optical components while avoiding the use of adhesives that may be subject to degradation and/or cause contamination within an optical system.

In a first aspect, a method is disclosed. The method comprising the steps of aligning a first optically transmissive substrate for mounting to a housing component, the first optically transmissive substrate comprising a first material that is different from a second material of the housing component, and bonding the first optically transmissive substrate to the housing component by irradiating a first surface of the first optically transmissive substrate, a second surface of the housing component, or both using one or more passes of a pulsed laser beam that is transmitted through the first optically transmissive substrate.

In another aspect, a method is disclosed. The method comprising the steps of setting an alignment configuration of a first material and a second material, the alignment configuration defining an interface between a surface of the first material and a surface of the second material based at least in part on a geometry of the first material and a geometry of the second material, and irradiating the interface using a pulsed laser beam that is transmitted through the first material or the second material, wherein the interface is irradiated at one or more bonding zones to bond the first material and the second material by at least partially melting the surface of the first material, the surface of the second material, or both.

In another aspect, an optical component is disclosed. The optical component comprising a first material and a second material that are bonded together at one or more bonding zones where at least partial melting of at least the first material or the second material has occurred by radiation from a pulsed laser source, the first material and the second material being bonded based at least in part on the at least partial melting, wherein at least one of the first material or the second material comprises an optically transmissive substrate, and wherein the first material and the second material exclude one or more organic adhesive materials.

### BRIEF DESCRIPTION OF THE DRAWINGS

FIG. 1 illustrates an example of a system that supports laser-bonded optical assemblies in accordance with one or more aspects of the present disclosure.

FIG. 2 illustrates an example of an optical assembly that supports laser-bonded optical assemblies in accordance with one or more aspects of the present disclosure.

FIG. 3 illustrates an example of an optical assembly that supports laser-bonded optical assemblies in accordance with one or more aspects of the present disclosure.

FIG. 4 illustrates an example of an optical assembly that supports laser-bonded optical assemblies in accordance with one or more aspects of the present disclosure.

FIG. 5 illustrates an example of an optical assembly that supports laser-bonded optical assemblies in accordance with one or more aspects of the present disclosure.

FIG. 6 illustrates an example of an optical assembly that supports laser-bonded optical assemblies in accordance with one or more aspects of the present disclosure.

FIG. 7 illustrates an example of an optical assembly that supports laser-bonded optical assemblies in accordance with one or more aspects of the present disclosure.

FIG. 8 illustrates an example of an optical assembly that supports laser-bonded optical assemblies in accordance with one or more aspects of the present disclosure.

FIG. 9 illustrates an example of an optical assembly that supports laser-bonded optical assemblies in accordance with one or more aspects of the present disclosure.

FIGS. 10 and 11 show flowcharts that supports laser-bonded optical assemblies in accordance with one or more aspects of the present disclosure.

### DETAILED DESCRIPTION

Optical systems may have various applications in research, medical procedures, fabrication and microfabrication processes, and manufacturing. For instance, optical systems may include imaging and illumination systems for applications such as photolithography, semiconductor inspection, microscope assemblies, polarization components, among other examples. Such optical systems may include various optical components, such as light sources (e.g., lasers, light-emitting diodes (LEDs)) and optical elements (e.g., transmissive elements, refractive elements, diffractive elements, lenses, windows, prisms, beam splitters), as well as other structural components, housing components, mechanical components, or the like (e.g., for supporting, holding, and/or positioning the optical elements). An optical system may thus include one or more optical assemblies having optics that are mounted to structural components of the system. Additionally, or alternatively, two or more optical components of an optical assembly may be mounted to one another.

Mounting such optical components to each other or to a structural component (or both) may be achieved through various techniques, including mechanical mounting and using adhesive materials (e.g., organic adhesive materials). Mechanical mounting techniques (e.g., using one or more fasteners, clamps, or other methods), however, are often imprecise and relatively costly to implement with both high stability and accuracy. On the other hand, adhesive materials may provide some degrees of freedom for the alignment of optics, but may suffer from longevity and contamination issues, particularly in relatively high-power operating environments, operating environments using some wavelengths (e.g., deep ultra-violet (DUV) wavelengths, extreme ultra-violet (EUV) wavelengths), as well as with relatively high-vacuum applications, among other examples.

For instance, some adhesives have limited durability and, in some cases, may degrade under the operational wavelengths and power levels of an optical system. As one example, elastomeric adhesive materials may provide some protection against contact forces (e.g., that cause vibration, shocks, or shifts) and differential thermal expansion, but may in some cases be associated with relatively weak bond strengths and require proper combinations of mechanical, optical, and chemical properties, which may be challenging to achieve, particularly in cases of medium- to high-manufacturing volumes and for use with some DUV optical systems and vacuum-based EUV optical systems. Further, some optical systems including light sources operating at relatively high-power levels may altogether preclude the use of adhesives for mounting optical components in the optical system, as the adhesive materials may be unable to withstand the operational environment of the system. Thus, the use of adhesives for bonding optical components may be limited, present challenges, and result in degradation and contamination issues in some applications, while being substantially unavailable for use in other cases.

The disclosed techniques provide for solutions that enable the use of a focused, high-power pulsed laser system to join (e.g., bond) transparent optical components or substrates to each other or to mounting components. For example, a pulsed laser may be focused on an interface defined by two surfaces of respective materials to bond the materials together. Here, respective optical components (e.g., optically transmissive substrates, optical housing, or other components) may be bonded together when the pulsed laser irradiates one or both of a first surface of a first optical component or a second surface of a second optical component or housing component, which may result in at least partial melting of at least one of the first surface or the second surface and bond the components together. In such cases, the materials of the optical components or housing components may be locally melted and may generate plasmas, thereby combining the materials in a permanent way at one or more locations and with a relatively small heat-affected zone (e.g., due to the relatively short duration of the pulsed laser light). Thus, the described techniques relate to aspects of laser “welding” to create opto-mechanical assemblies, including assemblies where adhesives cannot be used or where adhesive performance may limit the stability and/or lifetime of the assemblies.

In some aspects, laser bonding of optical components may be used to bond similar or dissimilar materials, which may be based on an alignment configuration between the materials (e.g., based on a positioning, a geometry, a size, a shape, number or location of points of contact, or any combination thereof, of the materials). As an example, an optical component (e.g., an optically transmissive substrate, such as a glass material) may be bonded to a housing or other structural component configured to support the optical component, and the bonding may be based on how the optical component is mounted to the housing (e.g., based on a number and/or placement of locations where the optical component and the housing are in contact when mounted). Additionally, or alternatively, multiple transparent optical components may be bonded to each other using the described laser bonding techniques, and such bonding may be similarly based on the alignment configuration between the transparent optical components (e.g., based on how and where the transparent optical components come into contact with each other for mounting). In any case, the optical components may be bonded to other optical components or housings using some pattern of laser light that is transmitted through at least one surface of a transparent optical component to irradiate the interface between components, creating one or more bonding zones. Further, the bonding may be based on irradiating locations where opposing surfaces of the optical components are some threshold (e.g., minimum) distance apart from each other. For example, the threshold distance may be a distance between about 0.0 μm and about 7.0 μm (or about 0.5 μm to about 6.5 μm, or about 1.0 μm to about 6.0 μm, or about 1.5 μm to about 5.5 μm, or about 2.0 μm to about 5.0 μm, or about 2.5 μm to about 4.5 μm, or about 3.0 μm to about 4.0 μm, or about 3.5 μm to about 5.0 μm, or about 0.0 μm to about 6.5 μm, or about 0.0 μm to about 6.0 μm, or about 0.0 μm to about 5.5 μm, or about 0.0 μm to about 5.0 μm, or about 0.0 μm to about 4.5 μm, or about 0.0 μm to about 4.0 μm, or about 0.0 μm to about 3.5 μm, or about 0.0 μm to about 3.0 μm, or about 0.0 μm to about 2.5 μm, or about 0.0 μm to about 2.0 μm, or about 0.0 μm to about 1.5 μm, or about 0.0 μm to about 1.0 μm, or about 0.0 μm to about 0.75 μm, or about 0.0 μm to about 0.5 μm, or about 0.0 μm to about 0.25 μm, or about 0.0 μm to about 0.1 μm). Additionally, or alternatively, the bonding may be achieved by irradiating the opposing surfaces with some threshold (e.g., minimum) number of passes of the laser light. In some aspects, the described techniques may enable two optical components to be laser bonded before being bonded (e.g., using the pulsed laser or other techniques) to a housing component. Similarly, an optical component may be laser-bonded to a housing component before being bonded to one or more other optical components.

Particular aspects of the subject matter described herein may be implemented to realize one or more of the following potential advantages. The use of the described laser bonding techniques may provide for permanent, stable bonds between respective components. Such bonds may be inorganic in some examples and may not degrade with some operational wavelengths and power levels of optical systems including such laser-bonded assemblies. Likewise, laser bonding of optical components may avoid contamination issues typically associated with adhesives having undesirable chemistry or outgassing properties. The described techniques may be further used to create seals (e.g., hermetic seals) between respective components, for example, to be used in pressurized or vacuum systems and applications. The bonded assemblies may be similarly used in high-power and high-vacuum optical systems with minimal risk of the bond weakening over the lifetime of the corresponding optical system. Moreover, mechanical stresses near the one or more bonding locations irradiated by the laser may be relatively localized (e.g., and located away from an aperture of the optical component), thereby minimizing impact on optical performance of the optical component.

Aspects of the disclosure are initially described in the context of systems used to bond optical components using a pulsed laser to create optical assemblies. Aspects of the disclosure are further illustrated by and described with reference to various optical assemblies and flowcharts that relate to techniques and apparatuses for laser-bonded optical assemblies.

This description provides examples, and is not intended to limit the scope, applicability, or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the disclosure.

It should be appreciated by a person skilled in the art that one or more aspects of the disclosure may be implemented in a system to additionally, or alternatively, solve other problems than those described herein. Further, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

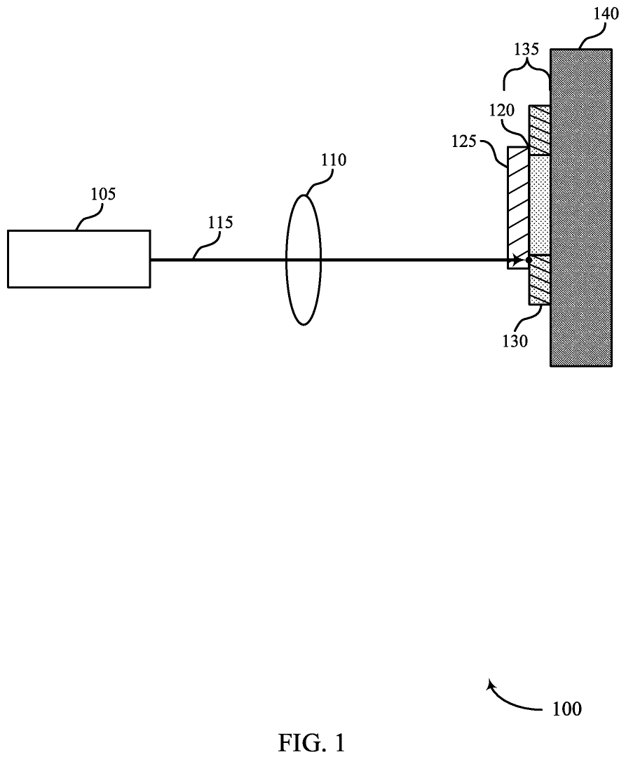

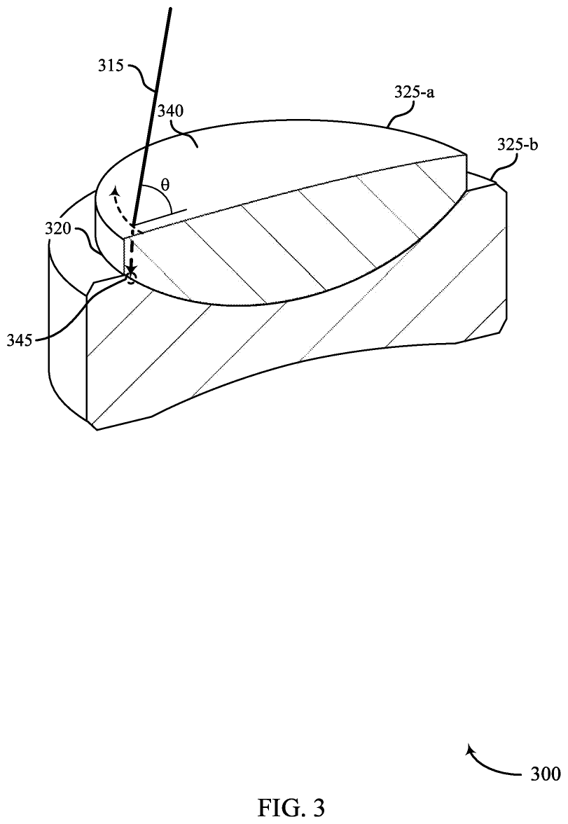

FIG. 1 illustrates an example of a system 100 that supports laser-bonded optical assemblies in accordance with one or more aspects of the present disclosure. The system 100 may include various components, such as a light source 105 and one or more optics 110. The one or more optics 110 may be configured to receive an output (e.g., laser beam 115) of the light source 105 and to focus the output on an interface 120 between a surface of an optical component 125 and a surface of a housing component 130. Here, the interface 120 may be defined by a first surface of the optical component 125 that faces, and is in contact with (e.g., one or more locations are within a threshold distance of), a second surface of the housing component 130. As such, the light source 105 and the one or more optics 110 may be configured to bond the first optical component 125 and the housing component 130 by irradiating the interface 120, which may result in localized melting (e.g., at least partial melting) of one or more of the respective materials of the first optical component 125 and the housing component 130 to bond the materials together. The laser beam 115 from the light source 105 may be scanned over one or more locations along the interface 120 a threshold number of times or for some duration to enable the bond. In some examples, the system 100 may support laser bonding of the optical component 125 with another, different optical component (such as described with reference to FIGS. 3, 4, and 7). The bonded optical components may comprise an optical assembly 135 for use in an optical system.

Optical system may have a range of applications and generally include some combination of refractive, reflective, or diffractive optical components that are mounted to each other and/or into housings or other structural components. Such assemblies may be combined with other components of the optical system (e.g., cameras, substrate stages, light sources) to function, for example, with performance specifications on transmission, transmission uniformity, wavefront performance, polarization performance, and alignment fidelity to perform some inspection, measurement, or lithographic function, among other examples.

Various techniques have traditionally been used for mounting optical components to each other or to optical housings (e.g., mounts, holders). For example, one or more components may be mechanically mounted, where rigid, stable mounting techniques may be used at the expense of relatively limited alignment performance and the incorporation of stress on the mounted components. In other examples, adhesives may be used to mount optical components to each other or to optical housings. For instance, some adhesive-based mounting techniques (such as elastomeric mounting) may enable some degree of alignment control of optical components, reduced stress, and reduction of fabrication complexity of the components. However, incorporation of an adhesive with the correct mix of mechanical, optical, and chemical properties for use in medium- to high-manufacturing volumes and for use with DUV systems (e.g., with operational wavelengths between about 280 nanometers (nm) and about 200 nm) or vacuum-based EUV systems (e.g., with operational wavelengths between about 124 nm and about 10 nm) may be challenging.

Further, some optical systems and related applications are associated with operations at relatively high-power levels, which may preclude the use of adhesives. For example, with applications that involve relatively high-power lasers (e.g., greater than about 100 milliwatts (mW)), relatively short wavelengths (e.g., ultraviolet (UV) wavelengths (e.g., wavelengths between about 400 nm and about 10 nm), DUV wavelengths, EUV wavelengths) or pulsed or broadband light sources, the use of adhesives may be limited because of issues related to contamination, outgassing, and/or durability (e.g., causing limited lifetime of the adhesive). In some cases, a clear aperture of optical components may be positioned relatively close to the adhesive application zones, and the adhesives may therefore be located within a contamination-sensitive space of an objective of the optical component, potentially resulting in performance issues due to the presence of the adhesive. Therefore, substitute mechanisms for joining the optical components in a way that is unaffected by the operational wavelength(s) of the optical system are desirable.

As described herein, improved techniques for mounting optical components to each other and to supporting components are disclosed. In particular, the described techniques may use a pulsed laser system focused on joining surfaces of components to be bonded together. In such cases, the light source 105 (e.g., a pulsed laser) provides relatively high energy output in relatively short durations to locally melt (e.g., at least partially melt) the materials together, which may then resolidify to create a permanent bond between the materials. The system 100 may be focused over an area in a pattern to adhere the materials within a zone. The bond between the materials forms an optical assembly 135 comprising at least two components (e.g., the optical component 125 and the housing component 130, two optical components 125). In addition, the pulsed laser may be scanned over the bonding locations some quantity of times (e.g., a threshold quantity of times, for some threshold duration of time) and in a pattern to bond the components together. The at least partial melting of material (and therefore, the bonding) may occur at one or more locations of the interface 120 where the respective surfaces of the components are some threshold (e.g., minimum) distance apart. In some aspects, the threshold distance may be a distance between about 0.0 μm and about 7.0 μm (or about 0.5 μm to about 6.5 μm, or about 1.0 μm to about 6.0 μm, or about 1.5 μm to about 5.5 μm, or about 2.0 μm to about 5.0 μm, or about 2.5 μm to about 4.5 μm, or about 3.0 μm to about 4.0 μm, or about 3.5 μm to about 5.0 μm, or about 0.0 μm to about 6.5 μm, or about 0.0 μm to about 6.0 μm, or about 0.0 μm to about 5.5 μm, or about 0.0 μm to about 5.0 μm, or about 0.0 μm to about 4.5 μm, or about 0.0 μm to about 4.0 μm, or about 0.0 μm to about 3.5 μm, or about 0.0 μm to about 3.0 μm, or about 0.0 μm to about 2.5 μm, or about 0.0 μm to about 2.0 μm, or about 0.0 μm to about 1.5 μm, or about 0.0 μm to about 1.0 μm, or about 0.0 μm to about 0.75 μm, or about 0.0 μm to about 0.5 μm, or about 0.0 μm to about 0.25 μm, or about 0.0 μm to about 0.1 μm). The interface 120 may be defined by a surface of the optical component 125 and a surface of the housing component 130 that form a common boundary between the optical component 125 and the housing component 130.

The optical component 125 may be bonded to the housing component 130 or another optical component in an area or region that is away from (e.g., outside of) an aperture of the optical component 125. In some embodiments, the optical component 125 may be circular, and the interface 120 may be irradiated at or near an edge or periphery of the optical component 125 and in an azimuthal direction near a circumference of the optical component 125. In such cases, there may be a continuous bonding zone near the circumference of the optical component 125, or there may be multiple discrete bonding zones near the circumference, which may be based on how the optical component 125 is to be mounted to the housing component 130, an alignment of the optical component 125, the respective shapes of the optical component 125 and the housing component 130, an application of the optical assembly 135, or any combination thereof.

Thus, the system 100 may be an example of a pulsed laser system that supports focused melting and joining of similar and dissimilar optically transparent components (such as optical component 125) to each other or to mounting surfaces or housings with a relatively high bonding strength, relatively small heat-affected zones, and without contamination. In some aspects, the light source 105 may be an example of a pulsed laser (e.g., a picosecond pulsed laser, a femtosecond pulsed laser, or the like) that is configured to operate at some wavelength of light, λ. As an example, the light source 105 may be configured to operate in UV wavelengths, infrared (IR) wavelengths (e.g., wavelengths between about 750 nm and about 1 millimeter (mm)), or other wavelengths between UV and IR (e.g., visible light having wavelengths between about 700 nm and about 400 nm). The light source 105 may generate optical power in multiple pulses (e.g., bursts) with some repetition rate. Each laser beam pulse may include a burst of multiple sub-pulses, and a duration of a sub-pulse may have some number of nanoseconds in duration, some number of picoseconds in duration, some number of femtoseconds in duration, among other example durations. The light source 105 may be a mode-locked laser, a Q-switching laser, a pulsed-pumping laser, among other examples, that generate a pulsed output (e.g., a non-continuous output). The light source 105, however, may be an example of another type of laser or light source not mentioned herein, and the examples described herein should not be considered limiting to the scope covered by the claims or the disclosure.

In some aspects, the wavelength of the laser beam 115 output by the light source 105 may be configured for bonding the optical component 125 and the housing component 130 by irradiating the interface 120. For instance, the wavelength, λ, of the light source 105 may be based on a material of the optical component 125 such that the optical component is substantially transparent to the laser light generated by the light source 105 (e.g., the optical component 125 may not absorb light output by the light source at the wavelength, λ). The system 100 may additionally, or alternatively, include a different quantity of (e.g., more) light sources 105 than illustrated, which may provide for additional flexibility and configuration of the system 100, thereby enhancing an ability to efficiently bond the optical component 125 and the housing component 130 (or to bond multiple optical components 125). Further, the light source 105 may be oriented differently than illustrated in system 100, which may enable the bonding of various optical components 125 having different shapes, positions, configurations, orientations, and applications.

The one or more optics 110 may be examples of optical elements (e.g., lenses, mirrors, light sources, prisms, detectors, screens, dispersing components, filters, thin films, and the like) used to modify the laser beam 115. In some aspects, the one or more optics 110 may be configured to focus the laser beam 115 output by the light source 105 on the interface 120 for laser bonding the optical component 125 and the housing component 130 (or for bonding multiple optical components 125 together). For example, the one or more optics 110 may focus the laser beam 115 through the optical component 125 such that the focal length of the one or more optics 110 coincides with a first surface of the optical component 125 or a second surface of the housing component 130, or both. Here, the first surface and the second surface face each other and are some distance (e.g., a threshold distance, a minimum distance) apart from each other, which may enable the bonding when irradiated by the laser beam 115. In some cases, the laser beam 115 may be directed over one or more locations of the interface 120 some quantity of times (e.g., over an area, using some pattern) using the one or more optics 110. That is, the one or more optics 110 (and/or a position of the light source 105) may enable the irradiation of the interface 120 at various locations and angles to bond the components together.

The optical component 125 may, in some cases, have a circular shape (e.g., a circular cylinder lens), but the optical component 125 may have other shapes or geometries, as described herein. The optical component 125 may be bonded (e.g., joined, held, attached, secured) to the housing component 130 using the laser beam 115 in accordance with the described techniques. The optical component 125 may be an example of an optically transmissive substrate (e.g., a substrate that enables the transmission of light at various wavelengths), which may be configured for refracting, reflecting, or diffracting light at wavelength(s) associated with one or more applications of an optical system. In some cases, the optical component 125 may be optically transmissive to one or more wavelengths of light output by the light source 105 such that electromagnetic radiation from the light source 105 (e.g., corresponding to the laser beam 115) substantially passes through the optical component 125. For instance, the transmittance of the optical component 125 may be greater than some percentage (e.g., greater than about 80 percent, greater than about 85 percent, or greater than about 90 percent) for normal incident light of a wavelength of the light source 105. In other examples, at least a portion of the light output by the light source 105 may be transmitted through the optical component 125. In any case, the transmissivity of the optical component 125 may enable the interface 120 to be irradiated by light from the light source 105 that is transmitted through the optical component 125 and focused on the interface 120.

Further, the optical component 125 may be configured for operation in one or more optical systems, for example, based on an application or use of the optical system. In some cases, the optical component 125 may include a material that is optically transmissive to light having wavelengths in the visible or DUV spectrum, among other example wavelengths, for use in an optical system operating at the corresponding wavelengths. In some cases, the optical component 125 may be an example of fused silica or an optical glass. For instance, the optical component 125 may comprise a glass material including, for example, an aluminosilicate glass material, an alkali-aluminosilicate glass material, an aluminoborosilicate glass material, an alkali-aluminoborosilicate glass material, a soda lime glass material, a borosilicate glass material, an alkali-borosilicate glass material, or other types of glass materials. In another examples, the optical component 125 may include a glass material having a relatively low coefficient of thermal expansion (CTE), which may be referred to as an ultra-low expansion glass material. In some aspects, the optical component 125 may be an example of a crystalline material, such as calcium fluoride (CaF₂), quartz, or other crystalline material. In other examples, the optical component 125 may include magnesium fluoride (MgF₂) or zinc selenide (ZnSe). Additionally, or alternatively, the optical component 125 may be another type of material or multiple materials, and the examples described herein should not be considered limiting to the scope of the claims or the disclosure.

Based on an application of an optical system (e.g., microscopy, imaging, photolithography, laser optics, medical applications, among other example applications), the optical component 125 may be positioned (e.g., aligned) and bonded to the housing component 130 (or to another optical component 125) based on some set of parameters (e.g., with some degree of precision) to ensure proper functionality of the optical system including the optical component 125 (and the optical assembly 135). An alignment configuration between the optical component 125 and the housing component 130 may be set prior to bonding the components together. More specifically, prior to one or more laser bonding processes that irradiate a surface of the optical component 125 or a surface of the housing component 130, or both, a position and/or orientation of the optical component 125 may be adjusted (e.g., modified) to satisfy one or more design parameters. As an illustrative example, the optical component 125 may be a lens, and inclusion of the optical component 125 in the optical system may require that the optical component 125 be aligned with one or more other lenses, mirrors, or other optical components of the optical system.

As such, before the optical component 125 is mounted (e.g., permanently mounted) to the housing component 130 using the described laser bonding techniques, the optical component 125 may be aligned in accordance with some predetermined specifications or parameters for the optical component 125. Techniques for aligning the optical component 125 (e.g., setting the alignment configuration) may include lateral alignment (e.g., displacement of the optical component 125 in one or more directions), angular alignment (e.g., tilting or tipping the optical component 125 to modify an optical axis of the optical component 125), rotational alignment (e.g., rotating the optical component 125 about the optical axis of the optical component 125), among other examples. Aligning the optical component 125 may result in an orientation and position of the optical component 125 with respect to the housing component 130 prior to the components being joined together. In some aspects, the alignment configuration may be achieved based on a location of one or more opposite surfaces to be bonded together, a position of one or more opposite surfaces to be bonded together, a shape of one or more facing surfaces to be bonded together, or any combination thereof. In some aspects, the optical component 125 may be aligned using a device or fixture (e.g., a vacuum chuck, or other device) that holds the optical component 125 and modifies the position and/or orientation of the optical component 125. In other aspects, the optical component 125 may be placed onto, and rest upon, a surface of the housing component 130 (or another optical component) prior to bonding.

In some cases, the housing component 130 may be an example of a mechanical component or other type of component configured to support one or more optical components (e.g., including optical component 125). The housing component 130 may include one or more metallic materials, or may include hardened materials, materials that receive various types of plating (e.g., electroless nickel), or materials that may be passivated. For example, the housing component 130 may be or include one or more metallic materials such as aluminum, stainless steel, among other examples. In some cases, the housing component 130 may include one or more plated materials (e.g., a material plated with nickel, zinc, tin, or the like), or the housing component 130 may additionally or alternatively include one or more anodized materials (e.g., anodized aluminum, aluminum alloys, magnesium, titanium, stainless steel, or the like). In some examples, the housing component 130 may include one or more low-expansion alloys (e.g., allows having relatively low thermal expansion rates), such as Invar (FeNi36), among other examples of low-expansion alloys. Other materials of the housing component 130 may be possible, and the examples provided herein should not be considered limiting.

In some aspects, the system 100 may include one or more positioning devices 140. In one embodiment, the positioning device 140 may be an example of a structural component (e.g., a metallic structural component) that supports the housing component 130 while the optical component 125 and the housing component 130 are bonded together using the incident laser beam 115. Here, the positioning device 140 may correspond to a reference location used for bonding the optical component 125 and the housing component 130. Additionally, or alternatively, the positioning device 140 may be configured to move or position the optical component 125 and the housing component 130, for example, prior to laser bonding and/or during the laser-bonding process. In one embodiment, the positioning device 140 may be an example of a rotation plate that is configured to rotate the optical assembly during the laser bonding process (e.g., to achieve bonding in an annular-shaped zone near a circumference of the optical component 125). Further, the one or more positioning devices 140 may be used to move or position the optical assembly 135, for example, after the bonding process (e.g., for further processing or for one or more other manufacturing processes).

In some embodiments, one or more absorption layers (e.g., metallic absorbing layers) may be applied to the optical component 125 and/or the housing component 130 to enhance adhesion (e.g., increase a bond strength) and broaden a processing window for joining similar and dissimilar materials. As an example, one or more layers of a metal or metal-oxide coating may be applied to the optical component 125 and/or the housing component 130. The absorption layer(s) may be applied on a surface (e.g., a portion of a surface) of the optical component 125 and/or the housing component 130. Here, the one or more absorption layers may be applied, for example, in an annular shape (e.g., at or near a circumference of the optical component) on a surface of the optical component 125, where the surface may correspond to the interface 120 between the optical component 125 and the housing component 130 (e.g., a surface of the optical component 125 that is in contact with and forms a common boundary with a surface of the housing component). The absorption layers may accordingly be used in one or more zones (e.g., along the interface 120) where laser bonding occurs (which may be referred to herein as bonding zones), and may improve bonding efficacy and allow for relatively larger process windows or increased mechanical performance of the optical assembly 135. That is, the absorbing layers may be any material that enhances the bonding between the optical component 125 and the housing component 130 (or between the optical component 125 and another optical component). In some aspects, the one or more absorption layers may comprise a thin film protection coating. In some examples, the one or more absorption layers may be between about 120 and 300 nanometers (nm) thick.

Thus, the system 100 may support enhanced bonding techniques for bonding optical components (such as the optical component 125) to other optical components or to housing components 130. The described bonding techniques may enable bonding of materials without the use of organic materials (e.g., organic adhesives), providing for mechanically robust bonds between materials, and the laser bonding described herein may further be associated with relatively high manufacturing throughput and efficiency. In particular, when the optical component 125 and the housing component 130 (or another optical component 125) are bonded together, the exclusion of organic adhesives my enable the optical component to be used in various operational environments where organic adhesives (e.g., adhesives with undesirable chemistry or outgassing properties) would otherwise break down, resulting in contamination issues and weakening the bond between components. Moreover, the use of laser bonding may result in relatively increased bond strengths between different components, which may enable the bonds of an optical assembly 135 to better withstand various stresses placed on the optical assembly 135 (e.g., during operation, during transit) as compared to when adhesives are used for bonding the components. The described laser-bonded optical assemblies 135 may thus include optical components 125 that have permanent, stable connection with one or more other components. In such cases, the bond enabled by the laser processing is inorganic and may not degrade with operational wavelengths and power levels of optical systems. Further, the bonded components may have little to no contamination that may otherwise be present with the use of adhesive materials (e.g., having undesirable chemistry or outgassing properties).

The described bonding processes may be used in conjunction with one or more other joining techniques to increase durability and the lifetime of connections over operating or non-operating environmental ranges (e.g., shipping, transportation, transients). For instance, the laser bonding supported by the system 100 may be used along with optical contacting techniques, where two or more components may first be bonded via optical contacting and then bonded at an interface using the pulsed laser beam 115 of the light source 105. Such techniques may be used to improve stability across temperature ranges or components with different CTEs. Additionally, or alternatively, the described laser bonding techniques may be used to create elastomeric hybrid optical assemblies, where one or more structures may be joined (e.g., bonded) to optical components 125, and adhesives (e.g., elastomeric adhesives) may be used in zones outside of optical volumes. In some other examples, the laser bonding techniques may be used for manufacturing flexural hybrid assemblies, where one or more flexural structures may be bonded to an optical component 125, which may serve to decouple stress from the optical component 125 while providing enhanced adjustability and alignment.

In some aspects, the optical component 125 may be bonded with one or more other components via the pulsed laser to create a seal between the components, which may enable use of the optical assembly 135 in pressurized or vacuum applications. Similarly, such assemblies may be used for mounting in relatively high-power and high-vacuum optical systems. As a result of the laser bonding, stress and/or material damage near the bonding location may be relatively localized (e.g., within an areas that is about 10s of micrometers (μm)), which may minimize impact of the bonding process on optical performance.

Additionally, the process and infrastructure for bonding (e.g., at ambient conditions, galvo- or computer numerical control (CNC)-driven laser position and focus) may be efficiently adapted to existing adhesive bonding processes and infrastructure. Such laser bonding techniques may provide relatively increased processing throughput achieved through relatively lower joining times (e.g., seconds versus many minutes) and may require relatively less operator skill, for example, through the use of computer-controlled equipment. Additionally, for scenarios when an absorbing layer is not used, blocking coatings for adhesive protection may not be needed, thereby avoiding additional costs in the manufacturing process.

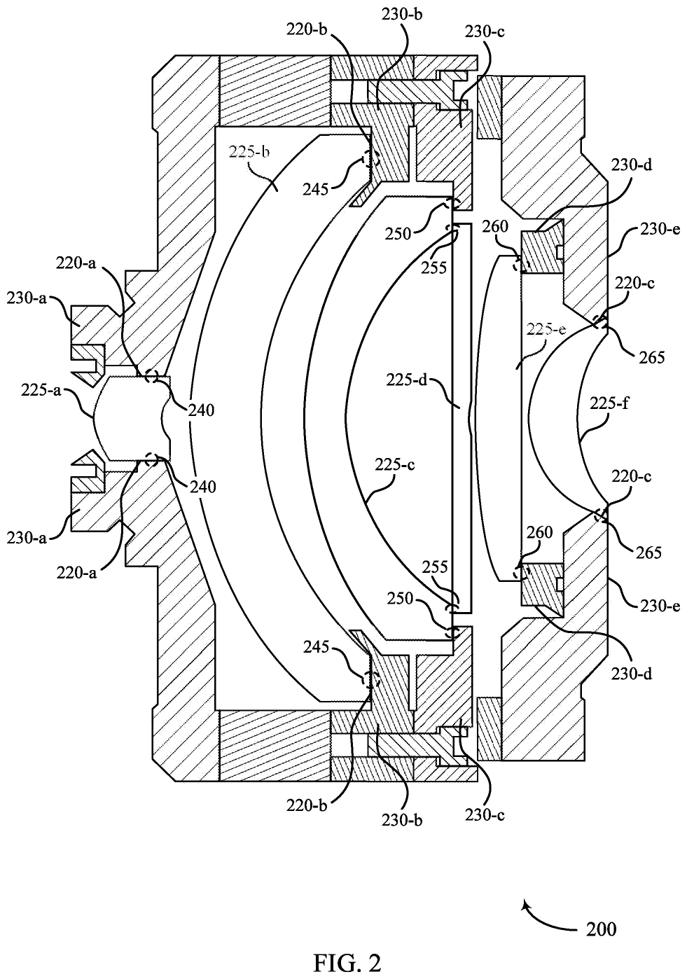

FIG. 2 illustrates a cross-sectional view of an example of an optical assembly 200 that supports laser-bonded optical assemblies in accordance with one or more aspects of the present disclosure. The optical assembly 200 may be an example of the optical assembly 135 described with reference to FIG. 1. For example, the optical assembly 200 may include multiple optical components (e.g., optical components 225-a, 225-b, 225-c, 225-d, 225-e, and 225-f) that are laser-bonded to respective housing components (e.g., housing components 230-a, 230-b, 230-c, 230-d, and 230-e) according to the described techniques. In addition, the optical assembly 200 may include one or more optical components that are laser-bonded to other optical components (e.g., a third optical component 225-c may be laser bonded to a fourth optical component 225-d). Each of the optical components may be an example of the optical component 125 described with reference to FIG. 1. For example, one or more of the respective optical components may be an example of an optically transmissive substrate. Similarly, each housing component may be an example of the housing component 130 described with reference to FIG. 1 that may, for example, include one or more metallic materials.

The various optical components (e.g., optical components 225-a through 225-f) of the optical assembly 200 may be bonded together, which may be based on respective alignment configurations of the optical and housing components. For example, the optical assembly 200 may be an example an objective (e.g., an optical element that gathers light from an object being observed and focuses light rays) that includes multiple optical components (e.g., optics that are configured for the refraction, reflection, or diffraction of light) that are bonded to one or more other optical components or to housing components (e.g., housings, holders, support components) to create the objective. Prior to bonding, each optical component of the optical assembly 200 is aligned such that the alignment of each optical component satisfies parameters associated with the functionality and operation of the optical assembly 200. For example, an optical component may be aligned with respect to one or more other optical components of the optical assembly 200, and a combination of the optical components may be aligned in accordance with an alignment configuration (e.g., to achieve design parameters of the optical assembly 200). As discussed above, the alignment configuration may result from an alignment of an optical component (e.g., lateral alignment, angular alignment, rotational alignment) with respect to one or more other optical components and/or housing components.

The optical assembly 200 may be an example of an objective having a six-element catadioptric design. Each optical component of the optical assembly 200 may be a circular lens, and an outer edge of the housing components may have a circular structure. The respective housing components (e.g., housing components 230-a through 230-e) may be connected to each other (e.g., bolted together) to form the assembly of the objective. Further, each housing component may surround (e.g., at least partially surround) one or more optical components of the optical assembly 200.

Each of the six optical components are supported near a periphery of the optical component to the housing components or to each other, where each optical component may be secured using the laser bonding techniques described herein. For example, a pulsed laser may be used to irradiate an interface between respective components at the peripheral locations to join (e.g., bond) the optical components to the housing components and to other optical components. The interface between components may be defined by a surface of an optical component and a surface of a housing component (or another optical component) that form a common boundary between the optical component and the housing component (or the other optical component). The optical components illustrated by the optical assembly 200 may each be circular, and an interface is understood to extend in an annular manner around the optical component (e.g., the optical component may be in annular contact with a corresponding housing component at one or more surfaces of the optical component, which corresponds to the interface). One or more of the optical component may be bonded to a housing component by irradiating (e.g., using a pulsed laser) the interface between the optical component and the housing component. The interface may be irradiated in a pattern or sequence of bonding zones (e.g., zones where bonding occurs between two materials), for example, at or near an edge of each optical component and in an azimuthal direction around the optical components. Thus, there may be a continuous bonding zone around the circumference of an optical component, or there may be multiple discrete bonding zones at or near the circumference or at other locations (e.g., as disclosed further below), which may be based on the alignment configuration or an application of the optical assembly 200, or both.

In an illustrative example, a first optical component 225-a may be laser bonded to a first housing component 230-a. In such cases, a pulsed laser may be incident on the first optical component 225-a and focused on an interface 220-a (which may be an example of an interface 120 described with reference to FIG. 1) between a surface of the first optical component 225-a and a surface of the first housing component 230-a. The pulsed laser may accordingly irradiate the surface of the first optical component 225-a or the surface of the first housing component 230-a, or both, to cause at least partial melting of a material of the first optical component 225-a or a material of the first housing component 230-a, or both.

In some examples, the pulsed laser (e.g., which may be an example of the light source 105 described with reference to FIG. 1) may be oriented or positioned based on how the first optical component 225-a is to be mounted to the first housing component 230-a (e.g., based on an orientation and position of the first optical component 225-a with respect to the first housing component 230-a).

Prior to bonding, the optical component 225-a may be aligned using various alignment techniques to achieve an alignment configuration that satisfies one or more parameters. In the present example, the optical component 225-a is a circular lens, and the optical component 225-a may be bonded to the housing component 230-a using outer-diameter bonding techniques, where an outer diameter of the optical component 225-a may be laser bonded to the housing component 230-a that surrounds the optical component 225-a. The pulsed laser beam may create one or more bonding zones 240 at the interface 220-a (e.g., in a relatively small radial space around a circumference of the first optical component 225-a). Additionally, or alternatively, one or more optics (such as the one or more optics 110 described with reference to FIG. 1) may be used to modify a direction or other parameters of the pulsed laser beam to irradiate the interface 220-a between the first optical component 225-a and the first housing component 230-a and create the bonding zone 240. In any case, the partial melting of material(s) at the bonding zone 240 may enable a relatively strong and permanent bond between the first optical component 225-a and the first housing component 230-a after the bonding process (e.g., after the materials have solidified). As such, the first optical component 225-a and the first housing component 230-a may be bonded without the use of an adhesive material, thereby avoiding one or more issues associated with optical adhesives within the optical assembly 200.

As further illustrated by the optical assembly 200, a second optical component 225-b may be laser bonded to a second housing component 230-b, for example, by irradiating an interface 220-b (which may be an example of the interface 120 described with reference to FIG. 1) between the second optical component 225-b and the second housing component 230-b. In such cases, a bonding zone 245 may be created in a relatively small radial space around (or near) the circumference of the second optical component 225-b where one or more materials of the second optical component 225-b or the second housing component 230-b, or both, are at least partially melted.

As further illustrated, the third optical component 225-c may be bonded to the third housing component 230-c, which at least partially surrounds the third optical component 225-c. In such cases, the pulsed laser may be focused at or near a circumference of the third optical component 225-c to create a bonding zone 250 (e.g., an annular bonding zone) around the third optical component 225-c. As such, the bonding zone 250 may include material of the third optical component 225-c or material of the third housing component 230-c, or both, that is at least partially melted and then resolidified to create a bond between the components. In addition, a fourth optical component 225-d may be laser bonded to the third optical component 225-c, for example, at one or more bonding zones 255 near a circumference of the fourth optical component 225-d (e.g., in a relatively small radial space near a circumference of the fourth optical component 225-d). Here, the third optical component 225-c and the fourth optical component 225-d may be bonded together before the third optical component 225-c is bonded to the third housing component 230-c. In other examples, the third optical component 225-c and the fourth optical component 225-d may be bonded together after the third optical component 225-c is bonded to the third housing component 230-c.

The fifth optical component 225-e may be laser bonded to a fourth housing component 230-d. In such cases, a bonding zone 260 may be created in a relatively small radial space around (or near) the circumference of the fifth optical component 225-e where one or more materials of the fifth optical component 225-e or the fourth housing component 230-d, or both, are at least partially melted by a pulsed laser.

In the optical assembly 200, a sixth optical component 225-f is laser bonded to a fifth housing component 230-e. In such cases, the sixth optical component 225-f may be positioned and/or oriented such that an outer surface of the sixth optical component 225-f is in contact with, or some threshold distance away from, an inner surface of the fifth housing component 230-e (e.g., comprising an interface 220-c between the sixth optical component 225-f and the fifth housing component 230-e, which may be an example of the interface 120 described with reference to FIG. 1). For example, the threshold distance may be a distance between about 0.0 μm and about 7.0 μm (or about 0.5 μm to about 6.5 μm, or about 1.0 μm to about 6.0 μm, or about 1.5 μm to about 5.5 μm, or about 2.0 μm to about 5.0 μm, or about 2.5 μm to about 4.5 μm, or about 3.0 μm to about 4.0 μm, or about 3.5 μm to about 5.0 μm, or about 0.0 μm to about 6.5 μm, or about 0.0 μm to about 6.0 μm, or about 0.0 μm to about 5.5 μm, or about 0.0 μm to about 5.0 μm, or about 0.0 μm to about 4.5 μm, or about 0.0 μm to about 4.0 μm, or about 0.0 μm to about 3.5 μm, or about 0.0 μm to about 3.0 μm, or about 0.0 μm to about 2.5 μm, or about 0.0 μm to about 2.0 μm, or about 0.0 μm to about 1.5 μm, or about 0.0 μm to about 1.0 μm, or about 0.0 μm to about 0.75 μm, or about 0.0 μm to about 0.5 μm, or about 0.0 μm to about 0.25 μm, or about 0.0 μm to about 0.1 μm). After the positioning of the sixth optical component 225-f, the interface 220-c between the sixth optical component 225-f and the fifth housing component 230-e may be irradiated by pulsed laser light (e.g., high-energy laser light) to bond the sixth optical component 225-f and the fifth housing component 230-e at one or more bonding zones 265 around a circumference of the sixth optical component 225-f. The bonding may be based on the distance between the surface of the sixth optical component 225-f and the facing surface of the fifth housing component 230-e satisfying a threshold (e.g., minimum) distance or based on a threshold (e.g., minimum) number of passes with the pulsed laser light, or both. In such examples, the sixth optical component 225-f may be bonded to the fifth housing component 230-e, for example, such that the bonding zone 265 may correspond to a relatively small space or area near an edge of a circumference of the sixth optical component 225-f and along an outer region of an optical surface or bevel of the sixth optical component 225-f.

The optical assembly 200 may therefore include one or more optical components that are bonded to a housing component or to each other using a pulsed laser beam. As a result, the optical assembly 200 may support increased durability, thereby enhancing the lifetime of the optical assembly 200. Further, the optical assembly may be free from some adhesive materials (e.g., adhesive materials), avoiding contamination or other issues associated with adhesives.

FIG. 3 illustrates a cross-sectional view of an example of an optical assembly 300 that supports laser-bonded optical assemblies in accordance with one or more aspects of the present disclosure. The optical assembly 300 may be an example of the optical assembly 135 described with reference to FIG. 1. For example, the optical assembly 300 may include a first optical component 325-a that is laser bonded to a second optical component 325-b according to the described techniques. The first optical component 325-a and the second optical component 325-b may each be an example of the optical component 125 described with reference to FIG. 1. For example, the first optical component 325-a and the second optical component 325-b may each be an example of an optically transmissive substrate.

The first optical component 325-a and the second optical component 325-b may be bonded based on an alignment configuration of the two components. As an example, the first optical component 325-a may be aligned with the second optical component 325-b based on one or more design specifications and/or operation of the optical assembly 300, where the first optical component 325-a and the second optical component 325-b are aligned prior to laser bonding of the first optical component 325-a and the second optical component 325-b. As illustrated, the optical assembly 300 may be an example of a doublet (e.g., a refractive doublet) comprising a convex optical component (e.g., the first optical component 325-a, which may be a bi-convex lens, a double-convex lens, or the like) and a concave optical component (e.g., the second optical component 325-b, which may be a concave lens, a bi-concave lens, or the like) that may have substantially a same radius of curvature on both sides of the respective components. In some aspects, the optical assembly 300 may function similarly to a plano-convex lens, for example, by focusing parallel rays of light to a single point) (e.g., via the first optical component 325-a) with the bi-concave element (e.g., the second optical component 325-b). In some examples, the first optical component 325-a and the second optical component 325-b may be initially bonded via contact bonding prior to being laser bonded. Contact bonding (e.g., optical contact bonding) may refer to one or more processes where highly-polished conformal surfaces are bonded without the use of adhesives. Instead, the bond is achieved through physical and intermolecular adhesion of the polished surfaces. In such cases, the contact bonding may be used to initially bond the first optical component 325-a and the second optical component 325-b, whereas the subsequent laser bonding of the first optical component 325-a and the second optical component 325-b may enable a more permanent bond between the first optical component 325-a and the second optical component 325-b. Here, the permanent bond achieved through laser bonding may increase a resistance to mechanical stresses placed on the optical assembly 300, such as vibrations during transport of the optical assembly 300, thereby enhancing the durability of the optical assembly 300.

In some aspects, the first optical component 325-a may be bonded to the second optical component 325-b at one or more bonding locations (or zones) of an interface 320 between the first optical component 325-a and the second optical component 325-b. Here, the interface 320 may be defined by a first surface of the first optical component 325-a and a second, opposite surface of the second optical component 325-b. The bonding may be achieved by irradiating one or more locations of the interface 320 using radiation from a pulsed laser beam 315 (e.g., which may be an example of the laser beam 115 described with reference to FIG. 1) that may at least partially melt the material of the first optical component 325-a or the material of the second optical component 325-b, or both, at the one or more locations of the interface 320.

To perform the bonding of the first optical component 325-a and the second optical component 325-b, the laser beam 315 may be focused through a top surface 340 of the first optical component 325-a (e.g., at some location and some angle, θ) to focus the laser beam 315 near an outer edge or zone of the mating curves between the first optical component 325-a and the second optical component 325-b to generate a bond (e.g., using one or more passes of the laser beam 315, using a threshold number of passes of the laser beam 315, irradiating the surfaces for some threshold duration). In such cases, the angle, θ, of the laser beam 315 (e.g., an angle of incidence) may correspond to an angle at which the light of the laser beam 315 is transmitted through the first optical component 325-a to enable the bonding of the first optical component 325-a and the second optical component 325-b. The angle may be configurable based on the first optical component 325-a (e.g., a material of the first optical component 325-a). In one example, the angle, θ, may correspond to a polarization angle (e.g., Brewster's angle) in which light having some polarization may be transmitted through the first optical component 325-a (e.g., an optically transmissive substrate), for example, without reflection. Other angles may be possible, for example, such that the laser beam 315 is transmitted through a volume of the first optical component 325-a and is incident on the interface for bonding the first optical component 325-a and the second optical component 325-b.

Here, the bond may exist in a bonding zone 345 as a continuous path azimuthally or exist at a plurality of discrete azimuthal locations, with some advantages and performance tradeoffs existing for strength and stress within the components near the bond (e.g., the bonding zone 345). In some aspects, the bonding zone 345 may be located some distance from an edge of the first optical component 325-a. For instance, the bonding zone 345 may be up to about 3 mm from the edge of the first optical component 325-a. In some cases, the location of the bonding zone may be configured to be some distance (e.g., about 100 μm, about 200 μm, or more) away from the edge of the first optical component 325-a so as to avoid damage to the edge of the first optical component 325-a. In addition, the bonding zone 345 may be located outside of a clear aperture of the first optical component 325-a (e.g., an area or volume where light may be transmitted through the first optical component 325-a), for example, to ensure functionality of the optical assembly 300. Further, knowledge of the location(s) (e.g., exact location(s)) of the zone(s) of contact between the first optical component 325-a and the second optical component 325-b (e.g., at or near the interface 320) may not be needed, as the laser beam 315 may be applied with some pattern (e.g., a raster pattern) within an area, and the bonding may take place where contact is made (e.g., for ambient temperature bonding processes (i.e., nano-second pulse durations of the laser beam 315) or within zones with relatively small gaps (i.e., pico- or femto-second pulse durations of the laser beam 315). That is, the bonding may occur in one or more irradiated locations where the distance between the first optical component 325-a and the second optical component 325-b satisfies some threshold distance. As an example, the threshold distance may be between about 0.0 μm and about 7.0 μm (or about 0.5 μm to about 6.5 μm, or about 1.0 μm to about 6.0 μm, or about 1.5 μm to about 5.5 μm, or about 2.0 μm to about 5.0 μm, or about 2.5 μm to about 4.5 μm, or about 3.0 μm to about 4.0 μm, or about 3.5 μm to about 5.0 μm, or about 0.0 μm to about 6.5 μm, or about 0.0 μm to about 6.0 μm, or about 0.0 μm to about 5.5 μm, or about 0.0 μm to about 5.0 μm, or about 0.0 μm to about 4.5 μm, or about 0.0 μm to about 4.0 μm, or about 0.0 μm to about 3.5 μm, or about 0.0 μm to about 3.0 μm, or about 0.0 μm to about 2.5 μm, or about 0.0 μm to about 2.0 μm, or about 0.0 μm to about 1.5 μm, or about 0.0 μm to about 1.0 μm, or about 0.0 μm to about 0.75 μm, or about 0.0 μm to about 0.5 μm, or about 0.0 μm to about 0.25 μm, or about 0.0 μm to about 0.1 μm). As a result, the first optical component 325-a and the second optical component 325-b may be bonded without the use of adhesive materials and may have a relatively strong, permanent bond.

The optical assembly 300 may therefore include optical components that are bonded to a housing component or to each other using a pulsed laser beam. As a result, the optical assembly 300 may be capable of withstanding operating environments using some wavelengths (e.g., DUV wavelengths, EUV wavelengths), as well as with relatively high-vacuum applications, among other applications.

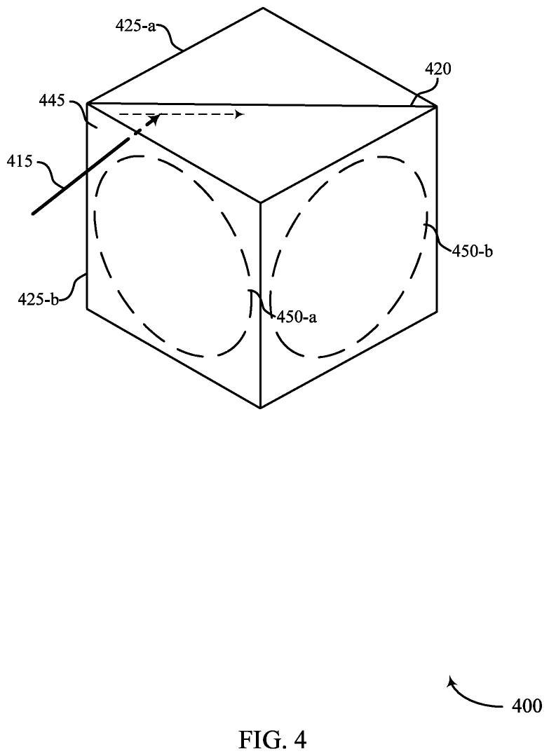

FIG. 4 illustrates an isometric view of an example of an optical assembly 400 that supports laser-bonded optical assemblies in accordance with one or more aspects of the present disclosure. The optical assembly 400 may be an example of the optical assembly 135 described with reference to FIG. 1. For example, the optical assembly 400 may include a first optical component 425-a that is laser bonded to a second optical component 425-b according to the described techniques. The first optical component 425-a and the second optical component 425-b may each be an example of the optical component 125 described with reference to FIG. 1. For example, the first optical component 425-a and the second optical component 425-b may each be an example of an optically transmissive substrate. In the optical assembly 400, the first optical component 425-a and the second optical component 425-b may each have a triangular shape. For instance, the first optical component 425-a and the second optical component 425-b may be a triangular prism. The optical assembly 400 may be an example that supports multiple bonding techniques, such as the use of contact bonding (e.g., optical contact bonding) that provides an initial bond between the first optical component 425-a and the second optical component 425-b (as described below), in addition to bonding using a pulsed high-energy laser that permanently and securely bonds the first optical component 425-a and the second optical component 425-b.

The first optical component 425-a and the second optical component 425-b may be bonded based on an alignment configuration of the two components. For instance, the optical assembly 400 may be an example of a cube beam splitter, and an alignment configuration may include the first optical component 425-a mounted to the second optical component 425-b using contact bonding. In particular, a beam splitting surface may be created by optically contacting the first optical component 425-a (e.g., a first right triangular prism) and the second optical component 425-b (e.g., a second right triangular prism) along the hypotenuse faces of the respective components. Contact bonding (e.g., optical contact bonding) may refer to one or more processes where highly-polished conformal surfaces are bonded without the use of adhesives. Instead, the bond is achieved through physical and intermolecular adhesion of the polished surfaces. Various techniques for contact bonding may be used to initially bond the first optical component 425-a and the second optical component 425-b. In such cases, the contact bonding may be used to initially bond the first optical component 425-a and the second optical component 425-b, whereas the subsequent laser bonding of the first optical component 425-a and the second optical component 425-b may enable a more permanent bond between the first optical component 425-a and the second optical component 425-b. Here, the permanent bond achieved through laser bonding may increase a resistance to mechanical stresses placed on the optical assembly 400, such as vibrations or thermal stresses occurring during transport of the optical assembly 400, thereby enhancing the durability of the optical assembly 400.

In addition, one or more laser beams 415 may be focused through one or many of the other surfaces (e.g., functional surfaces) of the cube beam splitter to the interface 420 between the first optical component 425-a and the second optical component 425-b (e.g., corresponding to the beam splitting surface) to join the respective components together permanently. As illustrated, the laser beam 415 may be incident on a first surface 445 of the second optical component 425-b, and the laser beam may be focused at the interface 420 for irradiating one or more facing surfaces of the first optical component 425-a and the second optical component 425-b (e.g., a surface of the first optical component 425-a or a surface of the second optical component 425-b, or both), for bonding the first optical component 425-a and the second optical component 425-b. The bonding may be performed in one or more patterns, and the interface 420 may be irradiated using continuous or discrete techniques. Further, bonding zones created by the irradiation of the interface 420 may occur outside of a clear aperture of the surface of the optical assembly 400. For example, the bonding zones may be set or configured to occur outside of aperture 450-a and aperture 450-b, such that optical performance of the optical assembly 400 is not affected by the laser bonding of the first optical component 425-a and the second optical component 425-b.

In some aspects, additional components (e.g., optical components, housing components) may be bonded to some other surfaces (e.g., nonfunctional surfaces (i.e., top or bottom surfaces)) of the first optical component 425-a or the second optical component 425-b for additional securing of the connections between the first optical component 425-a and the second optical component 425-b (e.g., the two halves of the cube beam splitter) or to mount to other components for further assembly with or adjacent to other optical assemblies in an optical system. Thus, the laser bonding techniques may enable efficient and reliable bonding of two or more optical components without the use of adhesive materials. Further, the optical assembly 400 may be capable of withstanding operating environments using some wavelengths (e.g., DUV wavelengths, EUV wavelengths), as well as with relatively high-vacuum applications, among other advantages.

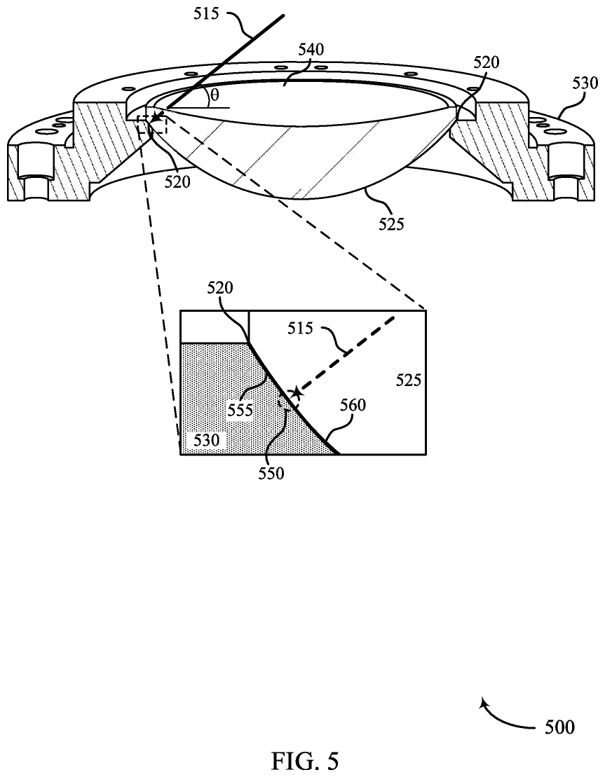

FIG. 5 illustrates a cross-sectional view of an example of an optical assembly 500 that supports laser-bonded optical assemblies in accordance with one or more aspects of the present disclosure. The optical assembly 500 may be an example of the optical assembly 135 described with reference to FIG. 1. For example, the optical assembly 500 may include an optical component 525 that is laser bonded to housing component 530 according to the described techniques. The optical component 525 may be an example of the optical component 125 described with reference to FIG. 1. For example, the optical component 525 may be an example of an optically transmissive substrate. The housing component 530 may likewise be an example of the housing component 130 described with reference to FIG. 1, which may, for example, include one or more metallic materials.

The optical component 525 and the housing component 530 may be bonded together based on an alignment configuration of the two components. As an example, the optical assembly 500 may be an example of a refractive lens element mounted to a housing (e.g., the housing component 530) near the periphery of the optical component 525 (e.g., a lens element). As illustrated, an interface 520 (e.g., a portion of the optical component 525 and the housing component 530 that are in contact or approximately in contact) may be based on the housing component 530 having a protrusion where the optical component 525 may be mounted and bonded. Here, the protrusion may have a surface 555 at or near an internal diameter of the housing component 530 that is locally tangent (e.g., nominally tangent) to a surface 560 of the optical component 525. In some cases, the surface 555 may have a geometry that approximately matches a local slope of a convex optical surface of the optical component 525 (e.g., the surface 560) at that location (e.g., around the circumference of the optical component 525). In some aspects, the internal diameter of the housing component 530 may have a conical shape. That is, the housing component 530 may include a conical hole such that an edge of the hole is configured to support a portion of the optical surface 560 the optical component 525 that is in contact with the conical hole.

When the optical component 525 is supported on its optical surface 560 and near the outside diameter of the optical component 525 by the surface 555 of the housing component 530, the interface 520 between the optical component 525 and the housing component 530 may be irradiated by a laser beam 515. The laser beam 515 may be used to locally melt (e.g., at least partially melt) a material of the optical component 525 or a material of the housing component 530, or both, to enable bonding between the optical component 525 and the housing component 530. In such examples, the laser beam 515 may be focused through a surface 540 of the optical component 525, and the laser beam 515 may be positioned and oriented (e.g., at some location, with some angle, θ) such that the laser beam 515 is focused on, and may create, a bonding zone 550 between the optical component 525 and the conical seat of the housing component 530. The bonding zone 550 may correspond to one or more locations of the interface 520 where the housing component 530 and the optical component 525 are permanently laser bonded. The angle, θ, of the laser beam 515 may be an angle configured to enable the laser beam 515 to be transmitted through a volume of the optical component 525 such that the laser beam 515 is incident on the interface 520 between the optical component 525 and the housing component 530. Further, the laser beam 515 may be rastered (or may be applied in some other pattern, in a continuous or non-continuous manner) to bond the optical component 525 and the housing component 530 at the bonding zone 550 in several regions or patterns, for example, in an azimuthal direction around a circumference of the optical component 525. In such cases, the bonding may occur in irradiated locations where the distance between the optical component 525 and housing component 530 satisfies some threshold (e.g., minimum) distance. For example, the threshold distance may be a distance between about 0.0 μm and about 7.0 μm (or about 0.5 μm to about 6.5 μm, or about 1.0 μm to about 6.0 μm, or about 1.5 μm to about 5.5 μm, or about 2.0 μm to about 5.0 μm, or about 2.5 μm to about 4.5 μm, or about 3.0 μm to about 4.0 μm, or about 3.5 μm to about 5.0 μm, or about 0.0 μm to about 6.5 μm, or about 0.0 μm to about 6.0 μm, or about 0.0 μm to about 5.5 μm, or about 0.0 μm to about 5.0 μm, or about 0.0 μm to about 4.5 μm, or about 0.0 μm to about 4.0 μm, or about 0.0 μm to about 3.5 μm, or about 0.0 μm to about 3.0 μm, or about 0.0 μm to about 2.5 μm, or about 0.0 μm to about 2.0 μm, or about 0.0 μm to about 1.5 μm, or about 0.0 μm to about 1.0 μm, or about 0.0 μm to about 0.75 μm, or about 0.0 μm to about 0.5 μm, or about 0.0 μm to about 0.25 μm, or about 0.0 μm to about 0.1 μm). Additionally, or alternatively, the bonding may occur in irradiated locations where the laser beam 515 passes over one or more locations some threshold (e.g., minimum) number of times or for some threshold (e.g., minimum) duration, or both. As a result, the optical component 525 and the housing component 530 may be bonded without the use of adhesive materials and may have a relatively strong, permanent bond achieved via relatively fast and efficient laser bonding processes.

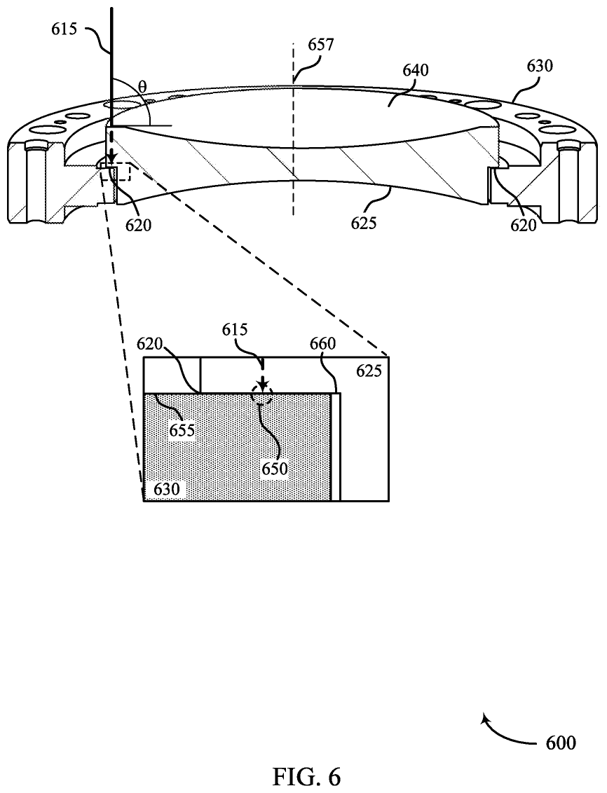

FIG. 6 illustrates a cross-sectional view of an example of an optical assembly 600 that supports laser-bonded optical assemblies in accordance with one or more aspects of the present disclosure. The optical assembly 600 may be an example of the optical assembly 135 described with reference to FIG. 1. For example, the optical assembly 600 may include an optical component 625 that is laser bonded to housing component 630 according to the described techniques. The optical component 625 may be an example of the optical component 125 described with reference to FIG. 1. For example, the optical component 625 may be an example of an optically transmissive substrate. The housing component 630 may likewise be an example of the housing component 130 described with reference to FIG. 1, which may, for example, include one or more metallic materials.

The optical component 625 and the housing component 630 may be bonded together based on an alignment configuration of the two components. As an example, the optical assembly 600 may be an example of a refractive lens element mounted to a housing (e.g., the housing component 630) near the periphery of the optical component 625 (e.g., a lens element). As illustrated, an interface 620 (e.g., a portion of the optical component 625 and the housing component 630 that are in contact) may be based on a bevel feature on the optical component 625 which may be nominally perpendicular to an optical axis (e.g., an axis of symmetry of the optical assembly 600) that matches a ledge near an inner diameter of the housing component 630. In this example, a bonding zone 650 may be located at a “nonfunctional” portion of an optical surface of the optical component 625, and may instead be a bevel or edge that may serve one or more other functions in a fabrication process or that may be dedicated for mounting (e.g., mounting the optical component 625 to the housing component 630). Put another way, the housing component 630 may include a top surface 655 that is perpendicular to a center axis 657 along a longitudinal length of a circular hole formed by an inner diameter of the housing component 630, where the top surface 655 is configured to support a surface 660 of an edge of the optical component 625. The surface 655 of the housing component 630 may be nominally tangent (or parallel) to the mating surface (e.g., surface 660) between the optical component 625 and the housing component 630. Where the surface 655 and the surface 660 meet may correspond to the interface 620.

When the optical component 625 is supported on the surface 660 of the edge (e.g., the bottom surface) and near the outside diameter of the optical component 625 by the top surface 655 of the housing component 630, the interface 620 between the optical component 625 and the housing component 630 may be irradiated by a laser beam 615 at one or more bonding zones 650. The laser beam 615 may be used to locally melt (e.g., at least partially melt) a material of the optical component 625 or a material of the housing component 630, or both, to enable bonding between the optical component 625 and the housing component 630. In such examples, the laser beam 615 may be focused through a surface 640 of the optical component 625, and the laser beam 615 may be positioned and oriented (e.g., at some location, with some angle, θ) such that the laser beam 615 is focused on the bonding zone 650 between the optical component 625 and the conical seat of the housing component 630. The bonding zone 650 may correspond to one or more locations of the interface 620 where the housing component 630 and the optical component 625 are permanently laser bonded. The angle, θ, of the laser beam 615 may be an angle configured to enable the laser beam 615 to be transmitted through a volume of the optical component 625 such that the laser beam 615 is incident on the interface 620 between the optical component 625 and the housing component 630. Further, the laser beam 615 may be rastered (or may be applied with some other pattern, in a continuous or non-continuous manner) to bond the bonding zone 650 in several regions or patterns, for example, in an azimuthal direction around a circumference of the optical component 625. In such cases, the bonding may occur in irradiated locations where the distance between the optical component 625 and housing component 630 satisfies some threshold (e.g., minimum) distance. Additionally, or alternatively, the bonding may occur in irradiated locations where the laser beam 615 passes over one or more locations some threshold (e.g., minimum) number of times or for some threshold (e.g., minimum) duration. As a result, the optical component 625 and the housing component 630 may be bonded without the use of adhesive materials and may have a relatively strong, permanent bond achieved via relatively fast and efficient laser bonding processes.

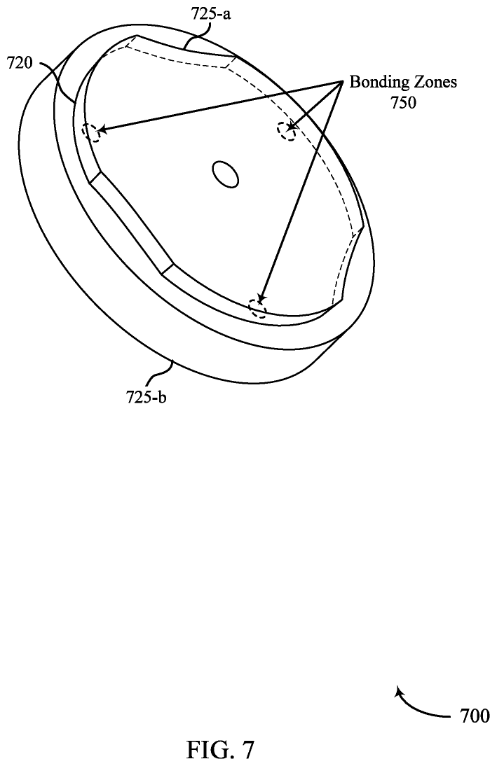

FIG. 7 illustrates an example of an optical assembly 700 that supports laser-bonded optical assemblies in accordance with one or more aspects of the present disclosure. The optical assembly 700 may be an example of the optical assembly 135 described with reference to FIG. 1. For example, the optical assembly 700 may include a first optical component 725-a that is laser bonded to a second optical component 725-b according to the described techniques. The first optical component 725-a and the second optical component 725-b may each be an example of the optical component 125 described with reference to FIG. 1. For example, the first optical component 725-a and the second optical component 725-b may be examples of optically transmissive substrates.

The first optical component 725-a and the second optical component 725-b may be bonded based on an alignment configuration of the two components. For instance, the optical assembly 700 may be an example of a catadioptric assembly at a plano-bevel interface. Here, the first optical component 725-a and the second optical component 725-b may be mounted to each other using a pulsed laser before being mounting further into an optical system (e.g., before being mounted to one or more other optical components, before being mounted to one or more housing components). In some examples, the optical assembly 700 may be an example of an optical subassembly that is part of an objective (e.g., as described with reference to the optical assembly 200 described with reference to FIG. 2, for example, corresponding to the third optical component 225-c and the fourth optical component 225-d). Here, the first optical component 725-a and the second optical component 725-b may include multiple (e.g., three) bonding zones 750 where the first optical component 725-a and the second optical component 725-b are in contact with each other. For example, each bonding zone 750 may correspond to some location between facing surfaces of the first optical component 725-a and the second optical component 725-b. That is, a laser beam may be transmitted through the volume of the first optical component 725-a to be incident at each bonding zone 750 to enable at least partial melting of one or more surfaces of the first optical component 725-a and/or the second optical component 725-b. In some aspects, the three bonding zones 750 may be prepared (e.g., prior to laser bonding) with a surface finish or one or more other processes to allow for bonding at the bonding zones 750.

Thus, each of the bonding zones 750 may be created by radiation via a pulsed laser beam that is focused on an interface 720 between a first surface of the first optical component 725-a and a second, opposite surface of the second optical component 725-b. The pulsed laser beam may irradiate one or more of the respective surfaces to cause the first optical component 725-a and the second optical component 725-b to be bonded together (e.g., through at least partial melting and subsequent solidification of one or more materials). Such techniques may enable the first optical component 725-a and the second optical component 725-b to be efficiently and relatively quickly bonded without the use of adhesive materials.

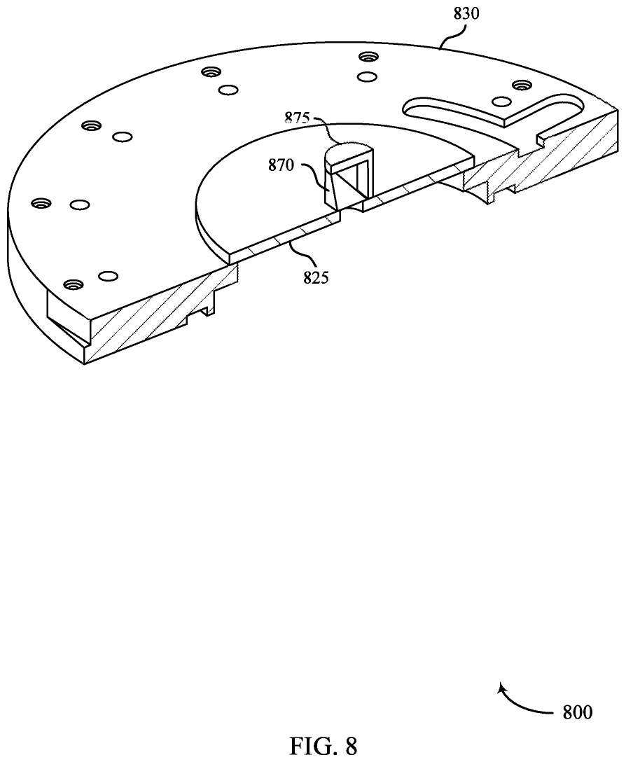

FIG. 8 illustrates a cross-sectional view of an example of an optical assembly 800 that supports laser-bonded optical assemblies in accordance with one or more aspects of the present disclosure. The optical assembly 800 may be an example of the optical assembly 135 described with reference to FIG. 1. For example, the optical assembly 800 may include an optical component 825 that is laser bonded to housing component 830 according to the described techniques. The optical component 825 may be an example of the optical component 125 described with reference to FIG. 1. For example, the optical component 825 may be an example of an optically transmissive substrate. The housing component 830 may likewise be an example of the housing component 130 described with reference to FIG. 1, which may, for example, include one or more metallic materials.

The optical assembly 800 may illustrate one or more functional components that may be laser bonded to the optical component 825 (e.g., either before or after the optical component 825 is bonded to the housing component 830). That is, the optical assembly may be an example of a multi-component assembly that is created through laser bonding of multiple different materials and components. As an example, the optical component 825 may have an optic 870 (e.g., a right triangular prism) that is bonded to the optical component 825, for example, using the described laser bonding techniques. In some examples, the optic 870 may be an example of an optically transmissive substrate, such as a glass material or a calcium fluoride material, among other examples. The optic 870 may be bonded to the optical component 825 by focusing a pulsed laser beam through the optical component 825 to one or more contact zones of the optic 870.

Further, a shielding component 875 (e.g., a blocking component) may be bonded to the optical component 825, where the shielding component 875 may serve to minimize or reduce stray light that may occur with an application of the optical assembly 800. In some examples, the shielding component 875 may include one or more metallic materials or other materials that may block or otherwise absorb or reflect light. The shielding component 875 may be bonded to the optical component 825 by focusing a pulsed laser beam through the optical component 825 to one or more contact zones of the shielding component 875.

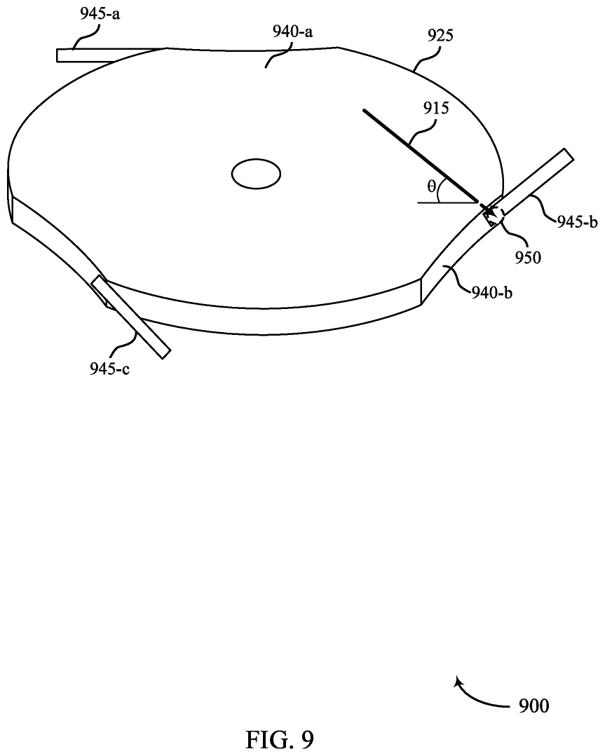

FIG. 9 illustrates an example of an optical assembly 900 that supports laser-bonded optical assemblies in accordance with one or more aspects of the present disclosure. The optical assembly 900 may be an example of the optical assembly 135 described with reference to FIG. 1. For example, the optical assembly 900 may include an optical component 925, which may be an example of the optical component 125 described with reference to FIG. 1. The optical component 925 may be an example of an optically transmissive substrate. The optical component 925 may have a variety of geometric shapes included in the circumference of the optical component 925. Additionally, or alternatively, the optical component 925 may have one or more bevel faces or other configurations.

The optical assembly 900 may further include one or more intermediate structures that may be bonded to the optical component 925 using a pulsed laser, as described herein. For example, the optical component 925 may be bonded to multiple (e.g., three) intermediate structural components, such as a first intermediate structural component 945-a, a second intermediate structural component 945-b, and a third intermediate structural component 945-c. The quantity, placement, configuration, shape, and location of each of the intermediate structural components 945-a, 945-b, or 945-c may be different, and the examples described herein should not be considered limiting to the scope of the claims or the disclosure.

In some aspects, the intermediate structural components 945-a, 945-b, or 945-c may include a metallic material or a glass material. In some examples, a material of the intermediate structural components 945-a, 945-b, or 945-c may include one or more flexible materials (such as some types of steel, among other examples) that support compression and/or bending of the intermediate structural components 945-a, 945-b, or 945-c without damage to the intermediate structural components 945-a, 945-b, or 945-c. The intermediate structural components 945-a, 945-b, or 945-c may enable improved contact between the optical component 925 and a housing component.

In some aspects, the intermediate structural components 945-a, 945-b, and 945-c may be bonded to an outside diameter of the optical component 925, as illustrated. The intermediate structural components 945-a, 945-b, and 945-c may be bonded using a pulsed laser (e.g., using the light source 105 described with reference to FIG. 1). As an illustrative example, a pulsed laser beam 915 may be focused through one or more surfaces of the optical component 925 (e.g., through a top surface 940-a), and the laser beam 915 may irradiate a first surface 940-b of the optical component 925, a surface of the second intermediate structural component 945-b facing the first surface 940-b, or both. In some embodiments, pulsed laser beam 915 may be focused through the intermediate structural component 945-a, 945-b, 945-c (when the structural component is transmissive to the laser beam), rather than through a surface of optical component 925 in order to irradiate the surface(s). The focused laser beam 915 may at least partially melt the first surface 940-b or the surface of the second intermediate structural component 945-b, or both, to create a bonding zone 950 where the second intermediate structural component 945-b and the optical component 925 are bonded together.

Each of the intermediate structural components may serve as a common intermediate connector to provide a range of connection configurations for a component configured to support the optical component 925. For example, a housing may comprise a corresponding side of the connection when the optical component 925 is mounted, for example, in an optical assembly. Here, the intermediate structural components 945-a, 945-b, and 945-c may be mounted to the housing using one or more additional laser-bonded joints, one or more mechanical connections (e.g., fasteners, bolts, screws, or the like), using an adhesive, or any combination thereof. In some aspects, the use of an adhesive to bond the intermediate structural components 945-a, 945-b, 945-c to the housing may be advantageous because a connection location (e.g., where an intermediate structural component is bonded to the housing) may be sufficiently far from the functional light of the optical system, and the adhesive may, in some cases, be shielded or purged with relatively improved protection (e.g., as compared to when the adhesive is adjacent to the optical component 925). Additionally, or alternatively, the intermediate structural components 945-a, 945-b, 945-c may include an absorbing layer or coating (e.g., a metal or metal oxide coating) for improved bonding strength.

In some other examples, the optical component 925 and the intermediate structural components 945-a, 945-b, 945-c may be integrated into or comprise an assembly of multiple components through laser bonding. Such an assembly may support features such as decoupling stress, providing adjustability (e.g., small or limited adjustability) to some specific degrees of freedom, provide thermal isolation or compensation to mechanical growth/shrinkage resulting from an environment or operation of the optical system including the optical component 925, or any combination thereof. In particular, one or more of the intermediate structural components 945-a, 945-b, or 945-c may be used as a bridge or buffer of material between the optical component 925 and a housing component, which may reduce or prevent one or more stresses (e.g., thermal stresses, mechanical stresses) on the optical component 925. In one example, the optical component 925 may be configured for use in a relatively high-stress environment (e.g., based on an application of an optical assembly in which the optical component 925 is included), and the intermediate structural components 945-a, 945-b, or 945-c, when attached to a housing component (e.g., via laser bonding or other techniques) may dampen any stresses that may otherwise be transferred from the housing component to the optical component 925. In some examples, a material of the optical component 925 may have a different CTE than a material of a housing component configured to hold the optical component 925. Here, the intermediate structural components 945-a, 945-b, or 945-c may reduce or minimize stresses on the optical component 925 that may result from the differences in the respective CTEs (e.g., when an optical assembly including the housing and the optical component 925 are subject to varying thermal conditions). In such examples, the optical component 925 may be coupled with the housing component via one or more of the intermediate structural components 945-a, 945-b, or 945-c (e.g., the optical component 925 may not be directly in contact with the housing component). In such cases, the intermediate structural components 945-a, 945-b, 945-c are laser bonded with one or more subassemblies prior to laser bonding to the optical component 925 or the housing (e.g., for mounting to the housing). Such techniques may be implemented using a plurality of materials capable of being laser bonded or using multiple material choices that are advantageous for design constraints related to stress, thermal performance, range of motion, vibration, or the like.

Additionally, or alternatively, the intermediate structural components 945-a, 945-b, or 945-c may provide enhancements to the manufacture of optical assemblies, such as when an optical assembly has limited space for bonding the optical component 925 to a housing component within the optical assembly. More specifically, a configuration or geometry of an optical assembly may have limited features (e.g., ledges, seats, or the like) that would otherwise enable a direct mounting of the optical component 925 to a housing component (e.g., due to space requirements or other constraints). The intermediate structural components 945-a, 945-b, or 945-c may enable additional flexibility for including the optical component 925 in the optical assembly. In such cases, the intermediate structural components 945-a, 945-b, or 945-c may provide one or more structures via which the optical component 925 is mounted to one or more housing components. The use of the intermediate structural components 945-a, 945-b, or 945-c may further enable further opportunities to align the optical component 925 and a housing component, for example, prior to permanently bonding the optical component 925 to the housing component (e.g., using laser bonding). The intermediate structural components 945-a, 945-b, or 945-c may first be bonded to the optical component 925 prior to the intermediate structural components 945-a, 945-b, or 945-c being bonded to the housing component. In other examples, one or more of the intermediate structural components 945-a, 945-b, or 945-c may be bonded to the housing component prior to bonding the optical component 925 to the intermediate structural components 945-a, 945-b, and/or 945-c. In any case, the use of structural components 945-a, 945-b, or 945-c, for example, between the optical component 925 and a housing component, may enable additional flexibility when designing and/or manufacturing optical assemblies.

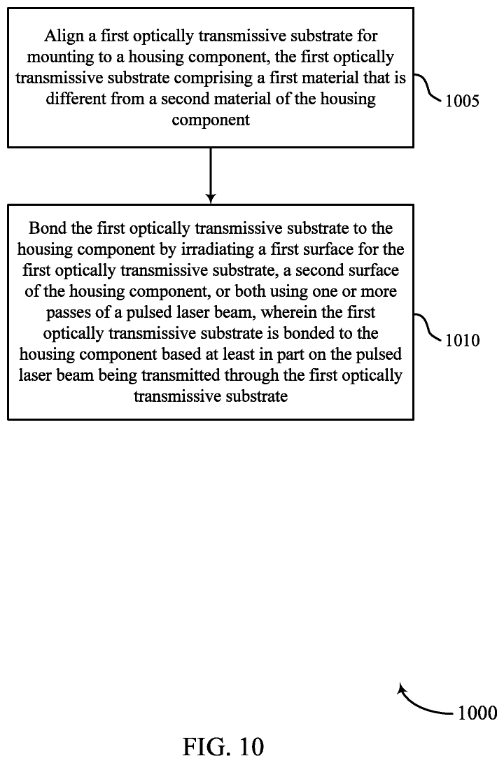

FIG. 10 shows a flowchart illustrating a method 1000 that supports laser-bonded optical assemblies in accordance with one or more aspects of the present disclosure. The operations of the method 1000 may be implemented by a device or its components as described herein. For example, the operations of the method 1000 may be performed by a system configured for bonding materials using a pulsed laser that irradiates an interface between the materials, as described with reference to FIGS. 1 through 9. In some examples, a device may execute a set of instructions to control the functional elements of the device to perform the described functions. Additionally, or alternatively, the device may perform aspects of the described functions using special-purpose hardware.

At 1005, the method may include aligning a first optically transmissive substrate for mounting to a housing component, the first optically transmissive substrate comprising a first material that is different from a second material of the housing component. The operations of 1005 may be performed in accordance with examples as disclosed herein.

At 1010, the method may include bonding the first optically transmissive substrate to the housing component by irradiating a first surface for the first optically transmissive substrate, a second surface of the housing component, or both using one or more passes of a pulsed laser beam, wherein the first optically transmissive substrate is bonded to the housing component based at least in part on the pulsed laser beam being transmitted through the first optically transmissive substrate. The operations of 1010 may be performed in accordance with examples as disclosed herein.

In some examples, an apparatus as described herein may perform a method or methods, such as the method 1000. The apparatus may include, features, circuitry, logic, means, or instructions (e.g., a non-transitory computer-readable medium storing instructions executable by a processor) for aligning a first optically transmissive substrate for mounting to a housing component, the first optically transmissive substrate comprising a first material that is different from a second material of the housing component; and bonding the first optically transmissive substrate to the housing component by irradiating a first surface for the first optically transmissive substrate, a second surface of the housing component, or both using one or more passes of a pulsed laser beam, wherein the first optically transmissive substrate is bonded to the housing component based at least in part on the pulsed laser beam being transmitted through the first optically transmissive substrate.

In some examples of the method 1000 and the apparatus described herein, the apparatus may include features, circuitry, logic, means, or instructions for bonding a second optically transmissive substrate to the first optically transmissive substrate by irradiating a third surface of the first optically transmissive substrate, a fourth surface of the second optically transmissive substrate, or both, using the pulsed laser beam, where the pulsed laser beam is transmitted through the first optically transmissive substrate or the second optically transmissive substrate. In some examples of the method 1000 and the apparatus described herein, the apparatus may include features, circuitry, logic, means, or instructions for bonding an assembly comprising both the first optically transmissive substrate and the second optically transmissive substrate to the housing component.

In some examples of the method 1000 and the apparatus described herein, the apparatus may include features, circuitry, logic, means, or instructions for bonding the first optically transmissive substrate to one or more structural components by irradiating a one or more surfaces of the first optically transmissive substrate, a respective surface of the one or more structural components, or both. In some examples of the method 1000 and the apparatus described herein, the apparatus may include features, circuitry, logic, means, or instructions for bonding an assembly comprising both the first optically transmissive substrate and the one or more structural components to the housing component.

In some examples of the method 1000 and the apparatus described herein, the apparatus may include features, circuitry, logic, means, or instructions for selecting a bonding pattern for the one or more passes of the pulsed laser beam, where the first optically transmissive substrate is bonded to the housing component at one or more bonding zones based on the bonding pattern. In some examples of the method 1000 and the apparatus described herein, the bonding pattern includes a raster pattern, a pattern of respective locations over the first surface, a pattern of respective locations over the second surface, or any combination thereof.

In some examples of the method 1000 and the apparatus described herein, the first optically transmissive substrate is bonded to the housing component based at least in part on a distance between the first surface and the second surface satisfying a threshold distance, or a quantity of the one or more passes satisfying a threshold quantity of passes, or both. In some examples of the method 1000 and the apparatus described herein, the threshold distance comprises a distance that is between about 0.0 μm and about 7.0 μm (or about 0.5 μm to about 6.5 μm, or about 1.0 μm to about 6.0 μm, or about 1.5 μm to about 5.5 μm, or about 2.0 μm to about 5.0 μm, or about 2.5 μm to about 4.5 μm, or about 3.0 μm to about 4.0 μm, or about 3.5 μm to about 5.0 μm, or about 0.0 μm to about 6.5 μm, or about 0.0 μm to about 6.0 μm, or about 0.0 μm to about 5.5 μm, or about 0.0 μm to about 5.0 μm, or about 0.0 μm to about 4.5 μm, or about 0.0 μm to about 4.0 μm, or about 0.0 μm to about 3.5 μm, or about 0.0 μm to about 3.0 μm, or about 0.0 μm to about 2.5 μm, or about 0.0 μm to about 2.0 μm, or about 0.0 μm to about 1.5 μm, or about 0.0 μm to about 1.0 μm, or about 0.0 μm to about 0.75 μm, or about 0.0 μm to about 0.5 μm, or about 0.0 μm to about 0.25 μm, or about 0.0 μm to about 0.1 μm).

In some examples of the method 1000 and the apparatus described herein, the apparatus may include features, circuitry, logic, means, or instructions for applying one or more absorbing layers to the first surface of the first optically transmissive substrate, the second surface of the housing component, or both, wherein the one or more absorbing layers comprise a metallic material, and wherein bonding the first optically transmissive substrate to the housing component is based at least in part on irradiating the one or more absorbing layers.

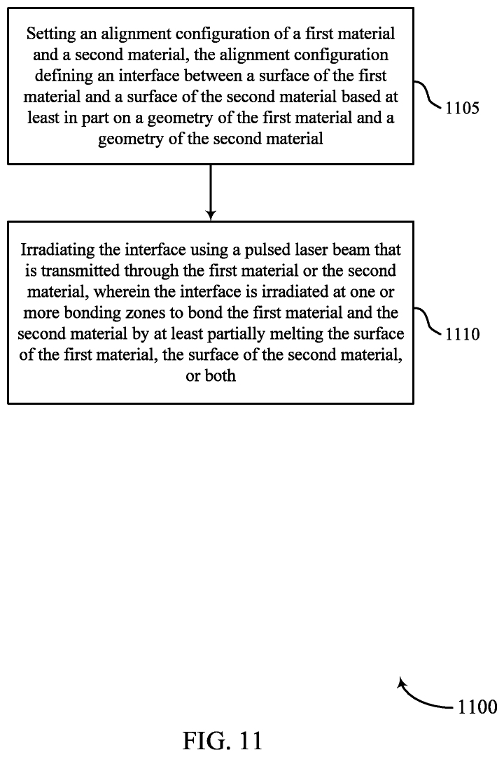

FIG. 11 shows a flowchart illustrating a method 1100 that supports laser-bonded optical assemblies in accordance with one or more aspects of the present disclosure. The operations of the method 1100 may be implemented by a device or its components as described herein. For example, the operations of the method 1100 may be performed by a system configured for bonding materials using a pulsed laser that irradiates an interface between the materials, as described with reference to FIGS. 1 through 9. In some examples, a device may execute a set of instructions to control the functional elements of the device to perform the described functions. Additionally, or alternatively, the device may perform aspects of the described functions using special-purpose hardware. The method 1100 may be used for bonding an optical component (e.g., an optically transmissive substrate) to another optical component or to a housing component.

At 1105, the method may include setting an alignment configuration of a first material and a second material, the alignment configuration defining an interface between a surface of the first material and a surface of the second material based at least in part on a geometry of the first material and a geometry of the second material. The operations of 1105 may be performed in accordance with examples as disclosed herein.

At 1110, the method may include irradiating the interface using a pulsed laser beam that is transmitted through the first material or the second material, wherein the interface is irradiated at one or more bonding zones to bond the first material and the second material by at least partially melting the surface of the first material, the surface of the second material, or both. The operations of 1110 may be performed in accordance with examples as disclosed herein.

In some examples, an apparatus as described herein may perform a method or methods, such as the method 1100. The apparatus may include, features, circuitry, logic, means, or instructions (e.g., a non-transitory computer-readable medium storing instructions executable by a processor) for setting an alignment configuration of a first material and a second material, the alignment configuration defining an interface between a surface of the first material and a surface of the second material based at least in part on a geometry of the first material and a geometry of the second material; and irradiating the interface using a pulsed laser beam that is transmitted through the first material or the second material, wherein the interface is irradiated at one or more bonding zones to bond the first material and the second material by at least partially melting the surface of the first material, the surface of the second material.

In some examples of the method 1100 and the apparatus described herein, the alignment configuration comprises an alignment of an optical doublet formed by the first material and the second material, the first material comprising a first optically transmissive substrate and the second material comprising a second optically transmissive substrate. In some examples of the method 1100 and the apparatus described herein, the apparatus may include features, circuitry, logic, means, or instructions for irradiating the one or more bonding zones near an edge of the first material to bond the first material to the second material.

In some examples of the method 1100 and the apparatus described herein, the apparatus may include features, circuitry, logic, means, or instructions for irradiating the one or more bonding zones along an azimuth of the first material, wherein the one or more bonding zones are continuously irradiated near the edge of the first material or are irradiated at a series of respective bonding zones near the edge of the first material.

In some examples of the method 1100 and the apparatus described herein, the first material is initially bonded to the second material via contact bonding, the first material comprising a first optically transmissive substrate and the second material comprises a second optically transmissive substrate. In some examples of the method 1100 and the apparatus described herein, the apparatus may include features, circuitry, logic, means, or instructions for irradiating the one or more bonding zones after the first material and the second material are bonded via the contact bonding.

In some examples of the method 1100 and the apparatus described herein, a conical hole formed by the second material is configured to support a portion of the surface the first material that is in contact with the conical hole, the first material comprising an optically transmissive substrate and the second material comprising a metallic material. In some examples of the method 1100 and the apparatus described herein, the apparatus may include features, circuitry, logic, means, or instructions for irradiating, at the one or more bonding zones along an azimuth of the first material, the portion of the surface of the first material to bond the first material and the second material, the portion of the first material being near an edge of the first material.

In some examples of the method 1100 and the apparatus described herein, a circular hole is formed by the second material and a top surface of the second material that is perpendicular to an axis of the circular hole is configured to support an edge of the first material, the first material comprising an optically transmissive substrate and the second material comprising a metallic material. In some examples of the method 1100 and the apparatus described herein, the apparatus may include features, circuitry, logic, means, or instructions for irradiating, at the one or more bonding zones along an azimuth of the first material, the surface of the first material that is in contact with the top surface of the second material to bond the first material and the second material.

In some examples of the method 1100 and the apparatus described herein, the first material comprises an optically transmissive substrate and the second material comprises a shielding component.

In some examples of the method 1100 and the apparatus described herein, the apparatus may include features, circuitry, logic, means, or instructions for irradiating the bonding zones at one or more locations that are away from an aperture of the first material, an aperture of the second material, or both, wherein the pulsed laser beam is focused on the interface through one or more surfaces of the first material, through one or more surfaces of the second material, or any combination thereof.

In some examples of the method 1100 and the apparatus described herein, irradiating the interface results in a hermetic seal at the interface. In some examples of the method 1100 and the apparatus described herein, the first material and the second material are bonded without one or more adhesive materials.

An optical component is described. The optical component may include a first material and a second material that are bonded together at one or more bonding zones where at least partial melting of at least the first material or the second material has occurred by radiation from a pulsed laser source, the first material and the second material being bonded based at least in part on the at least partial melting, wherein at least one of the first material or the second material comprises an optically transmissive substrate, and wherein the first material and the second material exclude one or more organic adhesive materials.

In some examples of the optical component, the first material is bonded to an intermediate structural component based at least in part on at least partial melting by the radiation of the pulsed laser source at a bonding zone between the first material and the intermediate structural component, and wherein the intermediate structural component is bonded to a housing component.

In some examples of the optical component, the optical component is configured for operation with a light source that outputs light having a wavelength less than about 280 nanometers and having a pulse energy that satisfies a threshold energy level.

In some examples of the optical component, the optical component is configured for operation in a vacuum, and wherein the first material and the second material have a hermetic seal based at least in part on being bonded together by the pulsed laser source.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for consumer preference and maintenance interface.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

As used herein, the term “about” means that the modified characteristic (e.g., a verb or adjective modified by the term substantially) or a related aspect (e.g., related action or function), need not be absolute but is close enough to achieve the advantages of the characteristic or related aspect (e.g., related action or function).

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The various illustrative blocks and modules described in connection with the disclosure herein may be implemented or performed with a general-purpose processor, a digital signal processor (DSP), a central processing unit (CPU), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise random-access memory (RAM), read-only memory (ROM), electrically erasable programmable read-only memory (EEPROM), compact disk (CD)ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
aligning a first optically transmissive substrate for mounting to a housing component, the first optically transmissive substrate comprising a first material that is different from a second material of the housing component; and
bonding the first optically transmissive substrate to the housing component by irradiating a first surface of the first optically transmissive substrate, a second surface of the housing component, or both using one or more passes of a pulsed laser beam that is transmitted through the first optically transmissive substrate.

2. The method of claim 1, further comprising:
bonding a second optically transmissive substrate to the first optically transmissive substrate by irradiating a third surface of the first optically transmissive substrate, a fourth surface of the second optically transmissive substrate, or both, using the pulsed laser beam that is transmitted through the first optically transmissive substrate or the second optically transmissive substrate, and
wherein bonding the first optically transmissive substrate to the housing component comprises bonding an assembly comprising both the first optically transmissive substrate and the second optically transmissive substrate to the housing component.

3. The method of claim 1, wherein bonding the first optically transmissive substrate to the housing component comprises:
bonding the first optically transmissive substrate to one or more structural components by irradiating one or more surfaces of the first optically transmissive substrate, a respective surface of the one or more structural components, or both, and
bonding an assembly comprising both the first optically transmissive substrate and the one or more structural components to the housing component.

4. The method of claim 1, wherein bonding the first optically transmissive substrate to the housing component comprises:
selecting a bonding pattern for the one or more passes of the pulsed laser beam, wherein the first optically transmissive substrate is bonded to the housing component at one or more bonding zones based at least in part on the bonding pattern, and wherein the bonding pattern comprising a raster pattern, a pattern of respective locations over the first surface, a pattern of respective locations over the second surface, or any combination thereof.

5. The method of claim 1, further comprising:
applying one or more absorbing layers to the first surface of the first optically transmissive substrate, the second surface of the housing component, or both, wherein the one or more absorbing layers comprise a metallic material, and wherein bonding the first optically transmissive substrate to the housing component is based at least in part on irradiating the one or more absorbing layers.

6. The method of claim 1, wherein the first optically transmissive substrate is bonded to the housing component based at least in part on a distance between the first surface and the second surface being between about 0.0 micrometers and about 7.0 micrometers.

7. A method, comprising:
setting an alignment configuration of a first material and a second material, the alignment configuration defining an interface between a surface of the first material and a surface of the second material based at least in part on a geometry of the first material and a geometry of the second material; and
irradiating the interface using a pulsed laser beam that is transmitted through the first material or the second material, wherein the interface is irradiated at one or more bonding zones to bond the first material and the second material by at least partially melting the surface of the first material, the surface of the second material, or both.

8. The method of claim 7, wherein the alignment configuration comprises an alignment of an optical doublet formed by the first material and the second material, the first material comprising a first optically transmissive substrate and the second material comprising a second optically transmissive substrate, and wherein irradiating the interface comprises:
irradiating the one or more bonding zones near an edge of the first material to bond the first material to the second material.

9. The method of claim 8, wherein irradiating the interface comprises:
irradiating the one or more bonding zones along an azimuth of the first material, wherein the one or more bonding zones are continuously irradiated near the edge of the first material or are irradiated at a series of respective bonding zones near the edge of the first material.

10. The method of claim 7, wherein the first material is initially bonded to the second material via contact bonding, the first material comprising a first optically transmissive substrate and the second material comprises a second optically transmissive substrate, and wherein irradiating the interface comprises:
irradiating the one or more bonding zones after the first material and the second material are bonded via the contact bonding.

11. The method of claim 7, wherein an edge of a conical hole formed by the second material is configured to support a portion of the surface the first material that is in contact with the conical hole, the first material comprising an optically transmissive substrate and the second material comprising a metallic material, and wherein irradiating the interface comprises:
irradiating, at the one or more bonding zones along an azimuth of the first material, the portion of the surface of the first material to bond the first material and the second material, the portion of the first material being near an edge of the first material.

12. The method of claim 7, wherein a circular hole is formed by the second material and a top surface of the second material that is perpendicular to an axis of the circular hole is configured to support an edge of the first material, the first material comprising an optically transmissive substrate and the second material comprising a metallic material, and wherein irradiating the interface comprises:
irradiating, at the one or more bonding zones along an azimuth of the first material, the surface of the first material that is in contact with the top surface of the second material to bond the first material and the second material.

13. The method of claim 7, wherein the first material comprises an optically transmissive substrate and the second material comprises a shielding component.

14. The method of claim 7, wherein irradiating the interface comprises:
irradiating the one or more bonding zones that are away from an aperture of the first material, an aperture of the second material, or both, wherein the pulsed laser beam is focused on the interface through one or more surfaces of the first material, through one or more surfaces of the second material, or any combination thereof.

15. The method of claim 7, wherein irradiating the interface results in a hermetic seal at the interface.

16. The method of claim 7, wherein the first material and the second material are bonded without one or more adhesive materials.

17. An optical component, comprising:
a first material and a second material that are bonded together at one or more bonding zones where at least partial melting of at least the first material or the second material has occurred by radiation from a pulsed laser source, the first material and the second material being bonded based at least in part on the at least partial melting, wherein at least one of the first material or the second material comprises an optically transmissive substrate, and wherein the first material and the second material exclude one or more organic adhesive materials.

18. The optical component of claim 17, wherein the first material is bonded to an intermediate structural component based at least in part on at least partial melting by the radiation of the pulsed laser source at a bonding zone between the first material and the intermediate structural component, and wherein the intermediate structural component is bonded to a housing component.

19. The optical component of claim 17, wherein the optical component is configured for operation with a light source that outputs light having a wavelength less than about 280 nanometers.

20. The optical component of claim 17, wherein the optical component is configured for operation in a vacuum, and wherein the first material and the second material have a hermetic seal based at least in part on being bonded together by the pulsed laser source.
